(19) United States
(12) Patent Application Publication
(10) Pub. No.: US 2026/0239073 A1
(43) Pub. Date: Aug. 13, 2026

(54) ENHANCED SENSING PROCEDURES

(71) Applicant: InterDigital Patent Holdings, Inc., Wilmington, DE (US)

(72) Inventors: Mahmoud SAAD, Montreal (CA); Zinan LIN, Basking Ridge, NJ (US); Rui YANG, Melville, NY (US); Hanqing LOU, Syosset, NY (US)

(73) Assignee: InterDigital Patent Holdings, Inc., Wilmington, DE (US)

(21) Appl. No.: 19/156,256

(22) PCT Filed: Feb. 23, 2024
(86) PCT No.: PCT/US2024/017098

§ 371 Date: Aug. 13, 2025

Related U.S. Application Data
(60) Provisional application No. 63/486,588, filed on Feb. 23, 2023.
(60) Provisional application No. 63/455,778, filed on Mar. 30, 2023.
(60) Provisional application No. 63/469,690, filed on May 30, 2023.
(60) Provisional application No. 63/472,486, filed on Jun. 12, 2023.
(60) Provisional application No. 63/524,120, filed on Jun. 29, 2023.
(60) Provisional application No. 63/533,257, filed on Aug. 17, 2023.
(60) Provisional application No. 63/586,640, filed on Sep. 29, 2023.

(51) Int. Cl. H04W 24/10

(52) U.S. Cl. CPC H04W 24/10

(57) ABSTRACT

Methods and devices are disclosed for a STA to initiate sensing by proxy (SBP) measurements from a sensing enabled access point (AP). In one method, the STA sends a sensing by proxy (SBP) request to the AP including an indicator, e.g., a report requested bitmap, designating one or more preferred receiver STAs requested to perform sensing measurements. The SBP request causes the AP to initiate sensing requests to the preferred receiver STAs, which may include the SBP initiating STA, and the STA receives a SBP response from the AP that includes a SBP sensing measurement report of sensing measurement results of the indicated preferred receiver STAs. Additional embodiments are disclosed.

### CROSS-REFERENCE TO RELATED APPLICATIONS

This application claims the benefit of U.S. Provisional Application No. 63/586,640, filed Sep. 29, 2023, U.S. Provisional Application No. 63/533,257, filed Aug. 17, 2023, U.S. Provisional Application No. 63/524,120, filed Jun. 29, 2023, U.S. Provisional Application No. 63/472,486, filed Jun. 12, 2023, U.S. Provisional Application No. 63/469,690, filed May 30, 2023, U.S. Provisional Application No. 63/455,778, filed Mar. 30, 2023, and U.S. Provisional Application No. 63/486,588, filed Feb. 23, 2023, the contents of all of which are incorporated herein by reference.

### BACKGROUND

In some wireless networks, a sensing element is used which contains fields for advertising optional sensing capabilities and sensing operation information. A sensing element may be present in, for example, a wireless local area network (WLAN) Association Request, Association Response, Reassociation Request, Reassociation Response, Probe Response and Sensing Measurement Setup Query frames of the network. Sensing measurement setup allows for a sensing initiator and a sensing responder to exchange and agree on operational parameters associated with sensing measurement instance(s) of a given measurement setup ID. A sensing initiator may transmit a sensing measurement setup request frame to a sensing responder to initiate a sensing measurement setup. Upon reception of a setup request, a sensing responder may transmit a measurement setup response frame to the sensing.

Existing networks do not provide a mechanism to exchange a puncturing pattern (which is a notification of subcarriers disabled for one or more reasons) of an unassociated non-access point (AP) station (STA) with a sensing AP during sensing measurement setup. There is a need for the ability to exchange the puncturing pattern between the sensing AP and the unassociated non-AP STA before the sensing measurement setup. Additionally, in WLAN sensing, an AP may announce the need for sensing responders in a sensing element, which may be exchanged in several management or action frames. This announcement may serve as invitation for responders to participate in potential trigger-based (TB) sensing measurement setups and corresponding TB sensing measurement instances in the future. There is a need for a non-AP STA to be able to indicate its willingness to participate in potential TB or initiate non-TB sensing measurement setups/instances as an early indication of availability.

In sensing measurement setups for trigger-based sensing measurement instances with unassociated STAs, a procedure to terminate unsuccessfully completed sensing measurement setups with unassociated STAs is needed.

Furthermore, an unassociated STA (U-STA) participating in a sensing session announces its sensing availability window to the sensing AP. Accordingly, the sensing AP may reach out for a sensing service only during the sensing availability window of the U-STA. On the other hand, if the serving AP (to which the U-STA is associated) has no knowledge about the sensing availability window of this U-STA, it may schedule the U-STA for DL transmission or TB UL transmission during a time this STA is already busy in a sensing session. In such scenario, the U-STA will not respond to its serving AP and transmission to this STA may get delayed beyond the maximum tolerable latency associated with this transmission for this STA. To avoid this inefficiency, a procedure is desirable to enable a STA to indicate its unavailability during a period of time to its serving AP.

In sensing-by-proxy (SBP), an SBP initiator (e.g., a non-AP STA) requests that a SBP responder (e.g., an AP) to perform sensing sessions and sensing measurement exchanges on its behalf. The SBP initiator may specify the list of preferred sensing responders to participate in the sensing sessions which will be initiated by the SBP responder (which also plays the role of a sensing initiator) to satisfy the SBP request from the SBP initiator (which may also play the role of a sensing responder). The SBP initiator may also specify the sensing roles of each responder in the preferred responders list as a sensing transmitter (sensing Tx), a sensing receiver (sensing Rx) or a sensing transmitter and receiver (sensing TxRx). It may also be useful to enable the SBP initiator to specify whether each of the sensing responders who are receivers if they are required to send the sensing measurement report back to the sensing initiator (which is also the SBP responder). A procedure which may allow the SBP initiator to specify whether a certain sensing receiver may be required to send the sensing measurement report or not, may be desirable.

### SUMMARY

One or more of the foregoing issues or needs may be addressed by aspects of the embodiments disclosed herein. In certain aspects methods and devices are disclosed to exchange a puncturing of an unassociated non-access point (AP) station (STA) with the sensing AP before sensing measurement setup. Additional aspects provide for a non-AP STA ability to participate in potential TB sensing setups or initiate non-TB sensing measurement setups/instances as an early indication of its abilities or availability.

In one example, aspects are disclosed which provide for enhanced frames or elements for punctured pattern indication by an unassociated STA (U-STA) to a sensing AP. In certain aspects an additional element is used in a sensing measurement setup query frame. A puncturing pattern indication may be included in the sensing measurement setup query frame and related access point (AP) behavior are disclosed. In other aspects, an uplink sounding procedure with puncturing is defined for the AP to solicit and receive a null data packet (NDP) from U-STAs. Yet further aspects may relate to a procedure to exchange channel information for U-STAs.

Other aspects are disclosed that provide for early indication of TB or non-TB sensing capability or initiation.

Additional aspects may relate to procedures to terminate unsuccessfully completed sensing measurement setup with unassociated STAs.

Further aspects of the disclosed embodiments relate to procedures to truncate a sensing transmission opportunity (TXOP)

Methods and devices are further disclosed for a U-STA to provide one of early announcement of sensing participation or subcarrier puncturing patterns to a sensing access point (AP). In trigger based (TB) operation, the U-STA may provide indications of sensing participation and/or puncturing patterns through a variety of enhanced frames, elements and subfields in wireless local area network (WLAN) messaging. Examples of puncturing pattern indicators include a sensing measurement setup query frame with puncture pattern indication, a sensing measurement setup response frame with puncturing pattern indication or a non-TB sensing specific sub element with puncturing pattern and methods for exchange with the AP. Additional aspects relate to signaling of early announcement for the U-STA to participate in TB and/or non-TB sensing with the AP. Specialized indicators in probe request/response frames and/or association request/response frames indicate whether the STA and/or AP will participate in TB and non-TB sensing prior to sensing setup procedures.

Additional aspects relate to procedures to signal unavailability of a U-STA. In one aspect, a power management field or an high througput control (HTC) field may be used to indicate unavailability of a U-STA.

Yet further aspects relate to methods and devices to signal to the responder receivers to report Sensing Measurements in Sensing-by-Proxy (SBP) operation. In one aspect, a procedure is defined to enable the SBP initiator to specify whether each of the sensing responders in the preferred responders list who is receiver or transmitter and receiver if they are required to send the sensing measurement report back to the sensing initiator or not.

In one example, a method for a STA may include sending a sensing by proxy (SBP) request to a sensing-enabled access point (AP) where the SBP request includes an indicator designating one or more preferred receiver STAs requested to perform sensing measurements. The STA receives a SBP response from the sensing-enabled AP including a SBP sensing measurement report having sensing measurement results of the indicated one or more preferred receiver STAs. Additional features and aspects are also disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of a sensing element format used in a wireless local area network (WLAN);

FIG. 3 is an example sensing field format of the sensing element of FIG. 2;

FIG. 4 is an example sensing measurement request frame action field format;

FIG. 5 is an example sensing comeback information field format;

FIG. 6 is an example sensing measurement setup response frame action field format;

FIG. 7 is an example sensing measurement parameters element format;

FIG. 8 is an example sensing measuring setup query frame action field format;

FIGS. 9A-9C are messaging diagrams showing a trigger based (TB) sensing measurement setup procedure for unassociated non-access point (AP) stations (STAs) and three respective differing options including a termination procedure;

FIG. 10 is an example format of a sensing measurement setup termination frame according to some embodiments;

FIG. 11 is a sensing by proxy (SBP) request frame according to an embodiment;

FIG. 12 is an example format of an SBP parameters element according to an embodiment;

FIG. 13 is an example format of an SBP parameters control field according to an embodiment;

FIG. 14 is an example format of a sensing measurement parameters element according to an embodiment;

FIG. 15 is an example format of a sensing measurement parameters field according to an embodiment;

FIG. 16 is a SBP response frame according to an embodiment;

FIG. 17 is an example modified sensing measurement setup query frame action field according to an embodiment;

FIG. 18 is an example modified sensing measurement setup response frame action field according to one embodiment;

FIG. 19 is an example modified non-TB sensing specific sub element according to an embodiment;

FIG. 20 is a message diagram showing an example enhanced TB sensing measurement setup procedure using the modified sensing measurement setup query frame of various embodiments;

FIG. 21 is a message diagram showing an example enhanced TB sensing measurement setup procedure using the modified sensing measurement setup response frame of certain embodiment;

FIG. 22 is a message diagram showing an example of an unassociated non-AP STA initiated non-TB sensing measurement setup procedure including a modified sensing measurement setup request frame of various embodiments;

FIG. 23 is an illustration of a first example puncturing channel pattern for multiple Unassociated STAs;

FIG. 24 is an illustration of a second example puncturing channel pattern for multiple Unassociated STAs;

FIG. 25 is a diagram showing Sensing Measurement Session Frame Exchange Between an Unassociated STA (U-STA) and a Sensing AP according to an embodiment;

FIG. 26 is a message diagram showing an example procedure for early indication of initiation of non-TB sensing measurement setups by non-AP STAs of certain embodiments;

FIG. 27 is a message diagram showing an example procedure for early indication of availability to participate in TB sensing measurement setups by non-AP STAs according to various embodiments;

FIG. 28 is an example of a network allocation vector (NAV) setting of a TB sensing measurement exchange;

FIG. 29 is a message diagram to indicate unavailability of an unassociated STA (U-STA) for sensing operation to its serving AP using a power management field according to an embodiment;

FIG. 30 is a flow diagram detailing a method for a U-STA to indicate unavailability for sensing operation to its serving AP;

FIG. 31 is a message diagram to indicate unavailability of a U-STA to a perform sensing operation to its serving AP using a high throughput control (HTC) field according to an embodiment;

FIG. 32 is a flow diagram detailing a method for a U-STA to indicate unavailability for sensing operation to its serving AP according to another embodiment;

FIG. 33 is a network diagram showing an example SBP session according to an embodiment with some sensing receivers requested to send a sensing measurement report and others not requested to send the sensing measurement report; and

FIG. 34 is an example method for a SBP initiating STA.

### DETAILED DESCRIPTION

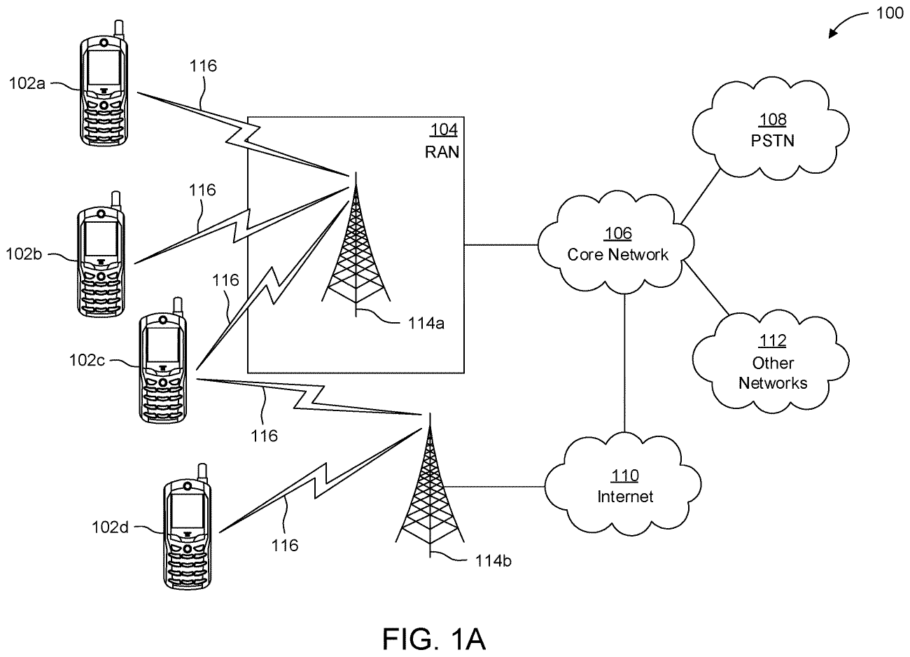

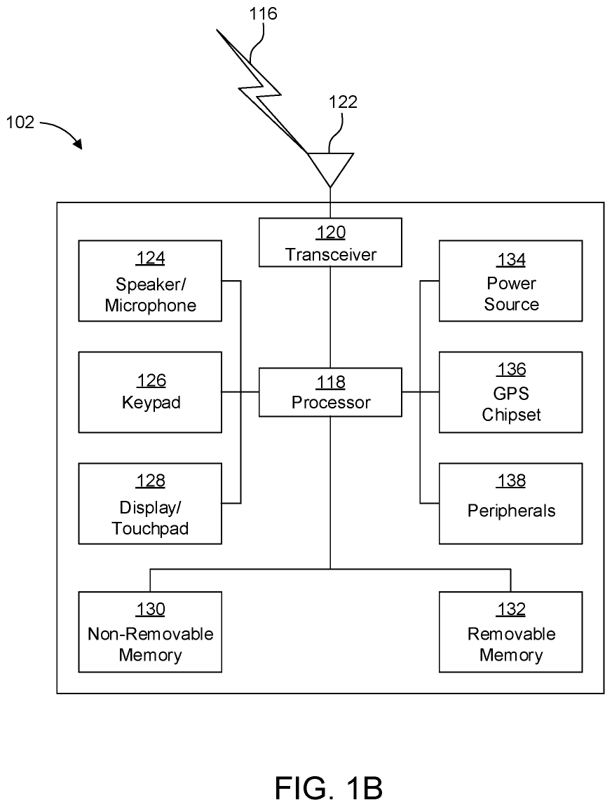

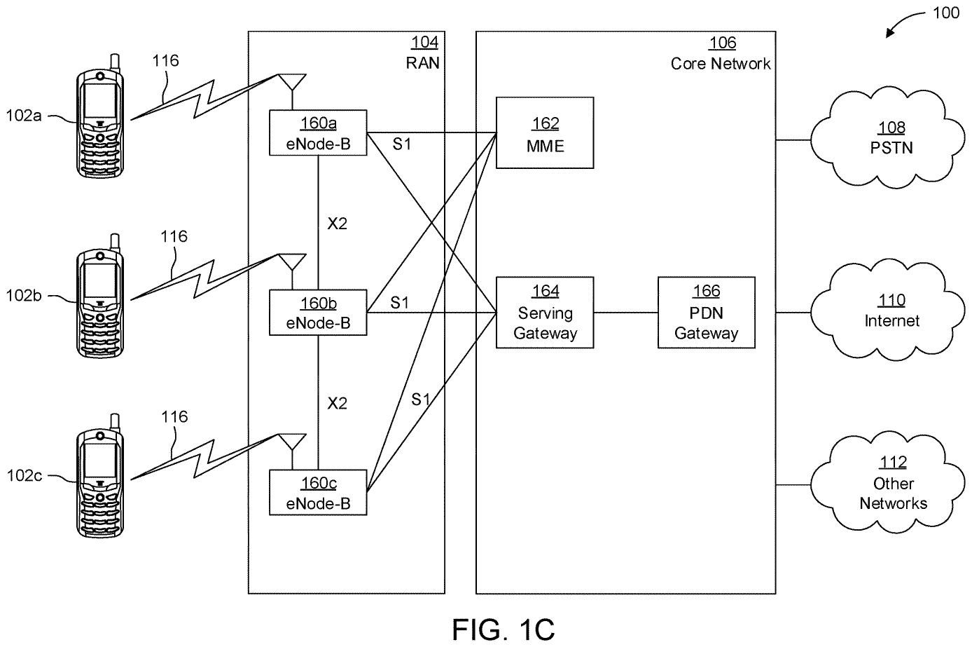

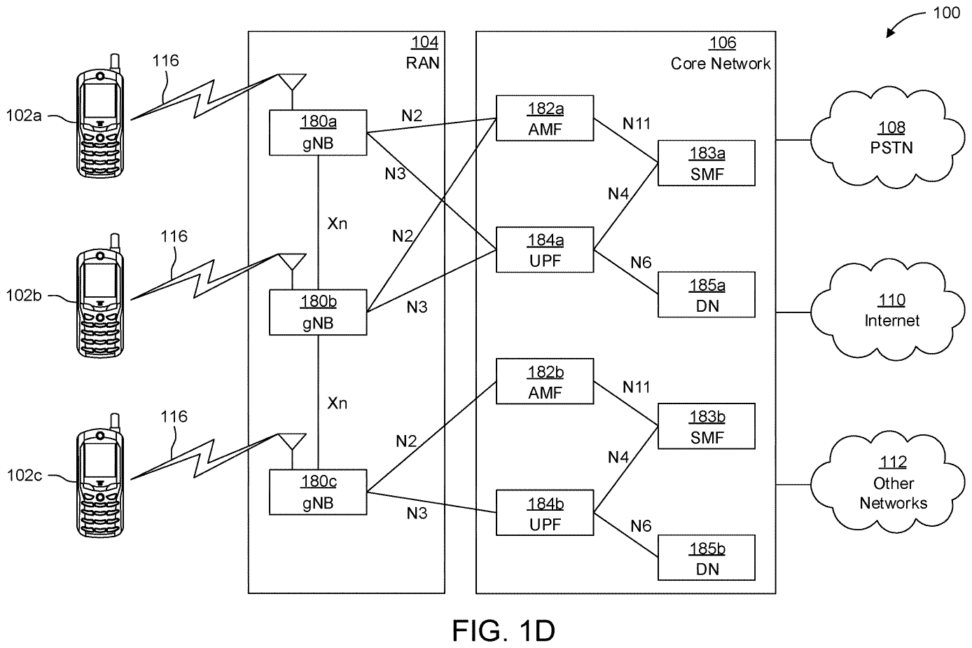

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As an overview of WLAN system a WLAN in infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to the destination STA.

Using the 802.11ac infrastructure mode of operation, the AP may transmit a beacon on a fixed channel, usually the primary channel. In some examples, this channel may be 20 MHz wide, and is referred to as the operating channel of the BSS. This primary channel is also used by STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the primary channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz secondary channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A160 MHz channel may be formed either by combining 8 contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time domain processing are done on each stream separately. The streams are then mapped on to the two channels, and the data is transmitted. At the receiver, this mechanism is reversed, and the combined data is sent to the MAC layer.

To improve spectral efficiency 802.11ac has introduced the concept for downlink Multi-User MIMO (MU-MIMO) transmission to multiple STA's in the same symbol's time frame, e.g., during a downlink OFDM symbol. The potential for the use of downlink MU-MIMO is also currently considered for 802.11ah. It is important to note that since downlink MU-MIMO, as it is used in 802.11ac, uses the same symbol timing to multiple STA's and interference of the waveform transmissions to multiple STA's is not an issue. However, all STA's involved in MU-MIMO transmission with the AP must use the same channel or band, which limits the operating bandwidth to the smallest channel bandwidth that is supported by the STA's which are included in the MU-MIMO transmission with the AP.

IEEE 802.11bf is proposed to be a new amendment to IEEE 802.11 for wireless sensing capability in WLAN. A new task group, TGbf, has defined a sensing procedure that allows a STA to perform WLAN sensing and obtain measurement results. A sensing session is an instance of a sensing procedure with associated operational parameters of that instance. A sensing initiator is a STA that initiates a WLAN sensing session. A sensing responder is a STA that participates in a WLAN sensing session initiated by a sensing initiator. A sensing transmitter is a STA that transmits physical layer convergence protocol data units (PPDUs) used for sensing measurements in a sensing session. A sensing receiver is a STA that receives PPDUs sent by a sensing transmitter and performs sensing measurements in a sensing session. A STA can assume multiple roles in one sensing session. For example, in a sensing session, a sensing initiator might be a sensing transmitter, a sensing receiver, both or neither.

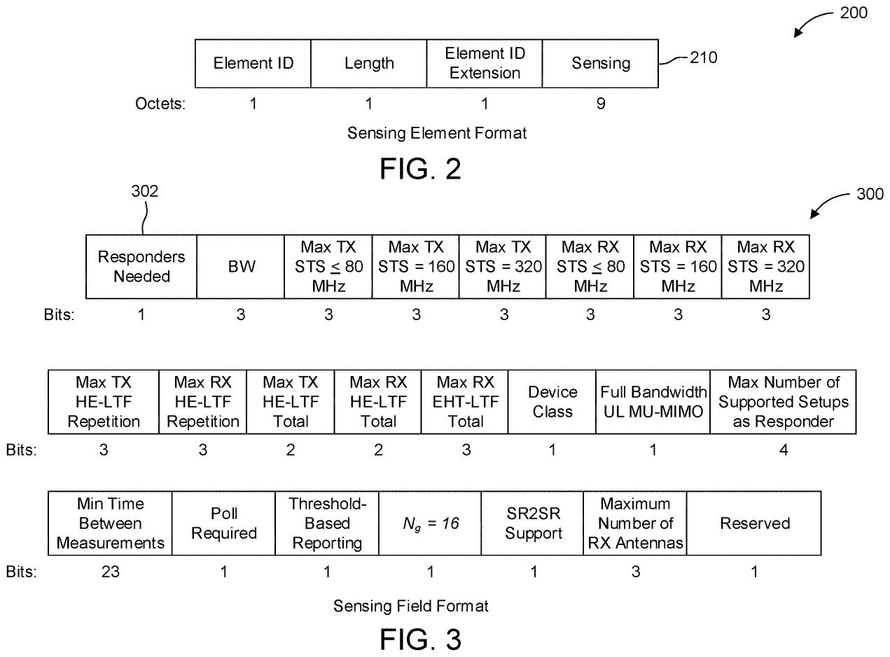

Referring to FIG. 2, an example sensing element 200 is shown. The Sensing element 200 contains one or more sensing fields 210 that are used to advertise optional sensing capabilities and sensing operation information. Sensing element 200 may be present in, for example, an Association Request, Association Response, Reassociation Request, Reassociation Response, Probe Response and Sensing Measurement Setup Query frames. FIG. 3 shows an example format 300 of sensing field 210 in sensing element 200 in FIG. 2.

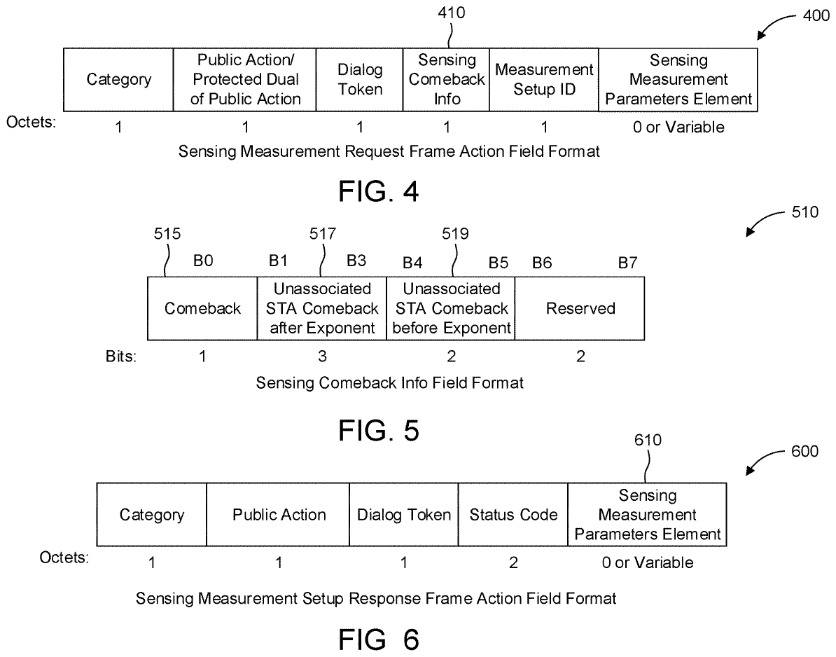

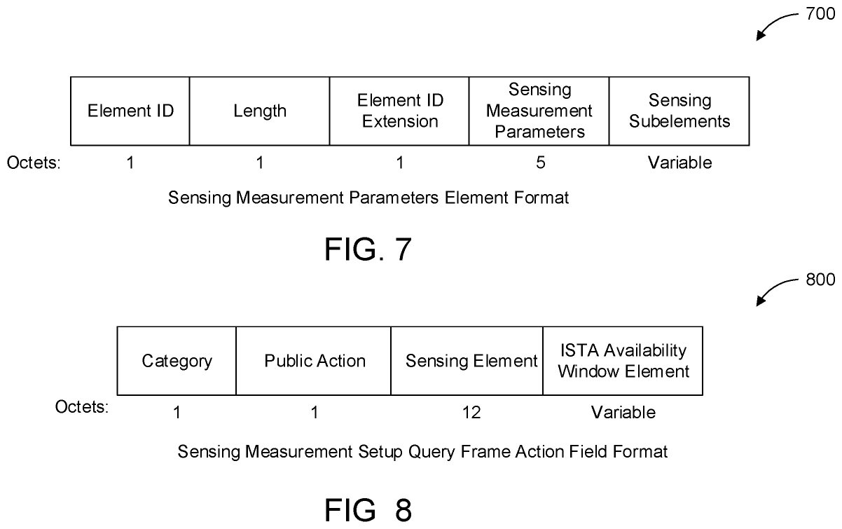

Sensing measurement setup allows for a sensing initiator and a sensing responder to exchange and agree on operational parameters associated with sensing measurement instance(s) of a given Measurement Setup ID. Referring to FIG. 4, a sensing initiator may transmit a Sensing Measurement Setup Request frame 400 to a sensing responder with which it intends to initiate a sensing measurement setup. Upon reception of a Sensing Measurement Setup Request frame (e.g., 400 of FIG. 4), the sensing responder may transmit a Sensing Measurement Setup Response frame to the sensing initiator which transmitted the Sensing Measurement Setup Request frame. Referring to FIG. 6, an example Sensing Measurement Setup Response frame 600 is shown, and may include a Sensing Measurement Parameters element 610 to indicate parameters and sub-elements of a sensing operation. FIG. 7 shows and example of a Sensing Measurement Parameters element format 700.

Referring back to FIG. 4, Sensing Measurement Setup Request frame 400 may include a Sensing Comeback Information field 410. FIG. 5 illustrates an example Sensing Comeback Info field format 510. In one example, Sensing Comeback Info field format 510 may include a Comeback field 515, and one or more Unassociated STA Comeback timing fields 517, 519. Upon reception of a Sensing Measurement Setup Request frame 400 of FIG. 4, with a Comeback subfield 410 having a format 500 of FIG. 5, and Comeback field 515 set=1, a non-AP STA may transmit a Sensing Measurement Setup Query frame (e.g. Setup Query frame 800 of FIG. 8) to the AP in a time specified in the Unassociated STA Comeback timing fields 517, 519, e.g., after a value specified in Unassociated STA Comeback After field 517 and before a time value specified in Unassociated STA Comeback Before value field 519. to solicit a Sensing Measurement Setup Request frame (e.g., frame 400 of FIG. 4) from the AP.

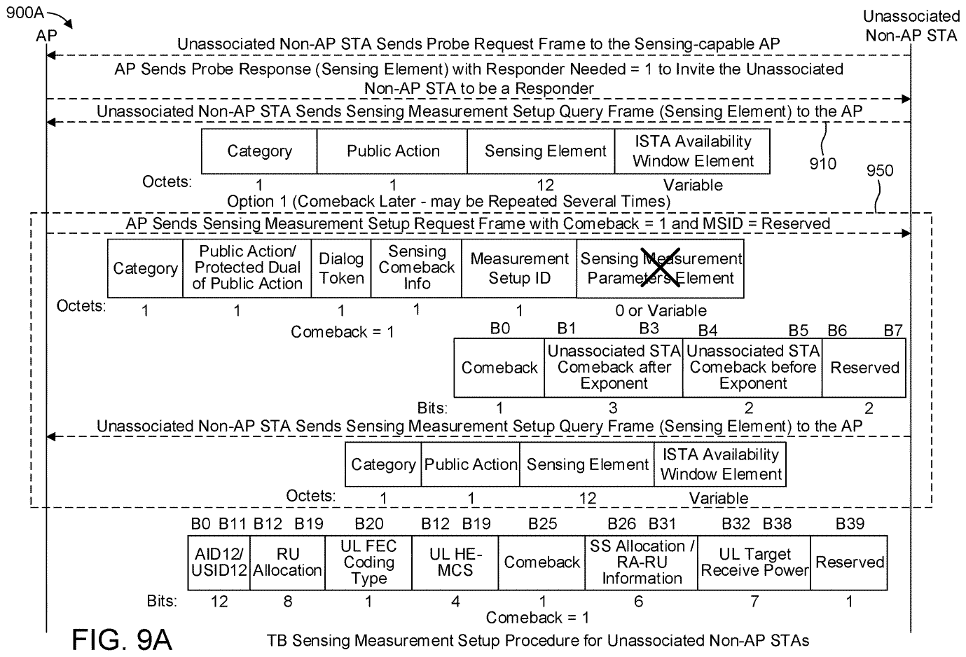

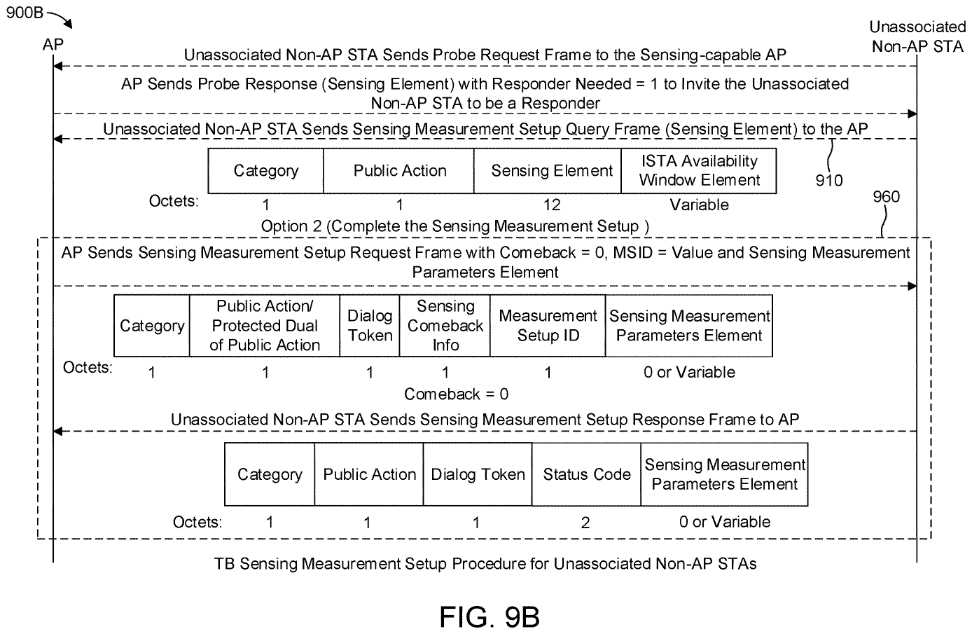

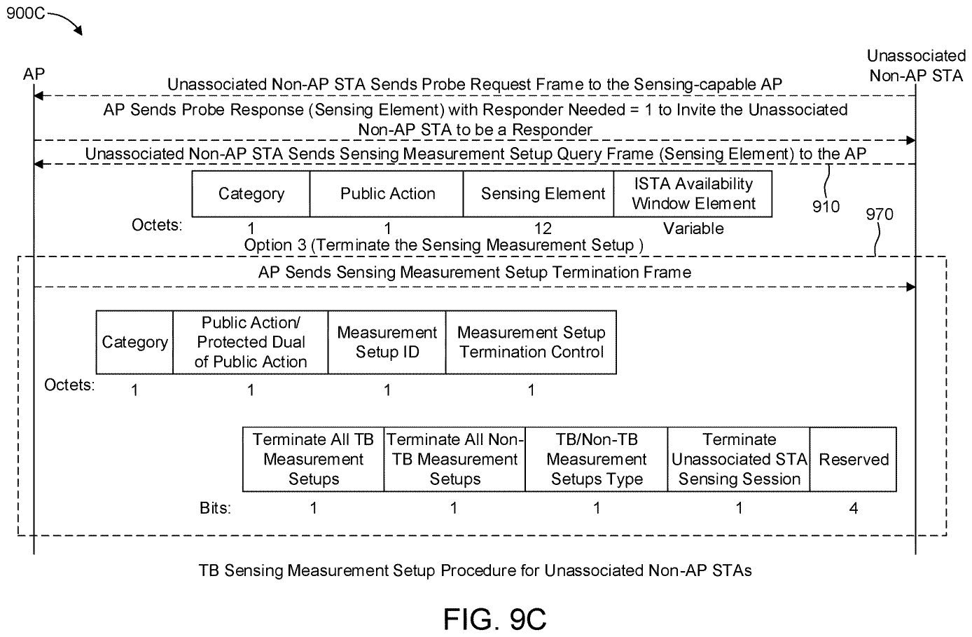

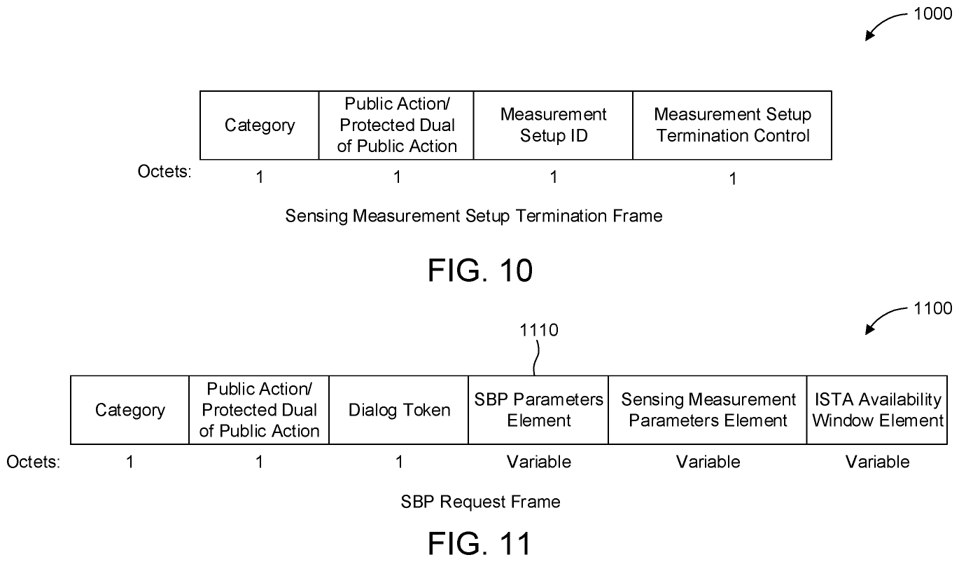

Referring to FIGS. 9A-9C, example methods 900A, 900B and 900C of operations are shown with respective varying options of outcome 950, 960 and 970. In methods 900A, 900B and 900C, both sides (i.e., the AP and U-STA) start a corresponding unassociated STA comeback timer when the exchange of the Sensing Measurement Setup Query frame 910 and/or the Sensing Measurement Setup Request frame with the Comeback subfield of the Sensing Comeback Info field set=1 completes. Any of the three method 900A, 900B and 900C options may follow the unassociated non-AP STA sending the first Sensing Measurement Setup Query frame 910. FIG. 9A shows example method 900A with Option-1 950 (shown within dashed lines). FIG. 9B shows example method 900B with Option-2 960 and FIG. 9C shows example method 900C with Option-3 970. In some embodiments, Option-2 960 may occur after repeating Option-1 950, for example one or more times. Option-3 970 is an example termination procedure and may occur if the AP repeated Option-1 950 a given amount of times and decided to drop the unassociated non-AP STA. FIG. 10 shows an example Sensing Measurement Setup Termination frame 1000 which may be used by the AP for this purpose.

In one example procedure for Enhanced Punctured Sensing for Unassociated STAs, an unassociated non-AP STA may have a puncturing pattern and/or a primary channel that are different from the sensing AP. Puncturing enables the use of a set of sparsely available bandwidths in diverse patterns to relieve restriction of contiguous channel bonding. The AP serving the unassociated non-AP STA may announce a puncturing pattern that is different from the puncturing pattern of the sensing AP and/or use a primary channel that is different from the sensing AP. As mentioned previously, currently, there is no mechanism to exchange the puncturing pattern of the unassociated non-AP STA with the sensing AP during the sensing measurement setup between this AP and the unassociated non-AP STA. Embodiments that follow provide a mechanism to exchange the puncturing pattern between the sensing AP and the unassociated non-AP STA before the sensing measurement setup.

In other embodiments, Enhanced Early Announcement of Availability for non-AP STA to Participate in trigger-based (TB) or non-TB Sensing are disclosed. In WLAN Sensing, an AP may announce the need for Sensing Responders in the Sensing element which may be exchanged in several management or action frames. This announcement may stand as invitation for responders to participate in potential TB sensing measurement setups and corresponding TB sensing measurement instances in the future. Currently, there is no mechanism for a non-AP STA to indicate if it is willing to participate as a Responder in those potential TB sensing measurement setups/instances as an early indication of its availability. Additionally, there is currently no ability for a non-AP STA to indicate that it is willing to initiate a non-TB sensing measurement setup/instance. Early indication of availability to participate in TB sensing measurement setups/instances or non-TB sensing measurement setup/instances for non-AP STA are disclosed herein.

Referring back to Sensing Field Format 300 of FIG. 3, the Responders Needed subfield 302 of the Sensing field in the Sensing element (e.g., 200 of FIG. 2) is used to announce that the AP needs responders. The Responders Needed subfield 302 may be set=1 to indicate the need for new sensing responders and is set=0 to indicate that new sensing responders are not needed. However, the behavior of the non-AP STAs in response to this invitation, and/or how subfield 302 is set by the AP (or potentially an initiating non-AP STA), are not specified, and may need to be defined. Inspired by these open issues, embodiments herein propose several uses for the Responders Needed subfield 302 and describe the corresponding behaviors to improve the sensing operation and/or to make it more efficient.

In further embodiments, procedures to terminate unsuccessfully completed sensing measurement setup with unassociated STAs are disclosed. In sensing measurement setups for TB sensing measurement instances with unassociated STAs, the unassociated STA may send a Sensing Measurement Query frame to the AP sensing initiator to offer being a responder. The AP sensing initiator may respond to this offer by one of: (i) terminating the sensing measurement setup; (ii) completing the sensing measurement setup; or (iii) requesting the unassociated STA to comeback to complete the sensing measurement setup in a specified period of time, as described previously with respect to FIGS. 9A, 9B and 9C. In some scenarios, an AP sensing initiator may be not ready to complete the sensing measurement setup when, for example, an unassociated STA comes back in the specified period, and the AP may request (optionally repeatedly) the unassociated STA to come back later. In this scenario, the AP sensing initiator may decide to terminate the sensing measurement setup before it completes. Embodiments to terminate unsuccessfully completed sensing measurement setups with unassociated STAs are disclosed to address this potential issue.

In further embodiments, an example procedure is disclosed to truncate the sensing transmission opportunity (TXOP). In some scenarios, the sensing initiator AP may fail to find any or enough responders to complete a sensing procedure. For example, the responders may not respond to a polling trigger frame with a clear-to-sent (CTS)-to-self frame and the AP may need to truncate the sensing TXOP to save the resource for other services. A procedure to enable the truncation of the sensing TXOP is desired.

In yet further embodiments, procedures for an unassociated STA (U-STA) participating in a sensing session are disclosed for indicating unavailability of the U-STA to its serving AP. As an example, the U-STA announces its sensing availability window to the sensing AP and the sensing AP may reach out for a sensing service, only during the sensing availability window, of the U-STA. However, if the serving AP (to which the U-STA is associated) has no knowledge about the sensing availability window of this U-STA, the serving AP may schedule the associated STA (which is a U-STA to the sensing AP) for DL transmission or TB UL transmission during a time this STA is already busy in a sensing session with a non-associated AP. In such scenario, the STA will not respond to its serving AP and transmission(s) to this STA may get delayed beyond the maximum tolerable latency associated with the transmission for this STA. To avoid this inefficiency, procedures are disclosed to enable a STA to indicate its unavailability during a period of time to its serving AP.

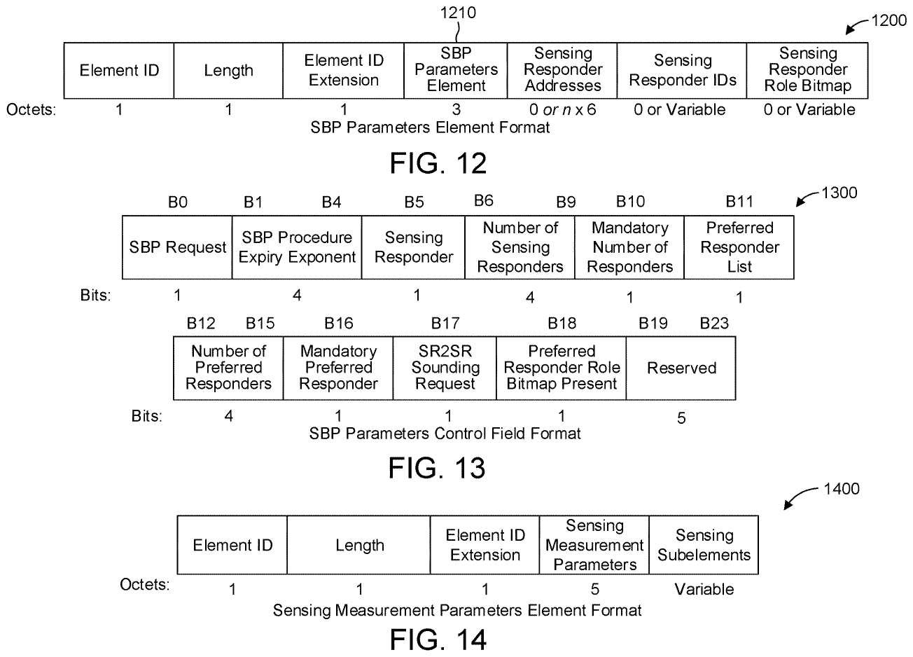

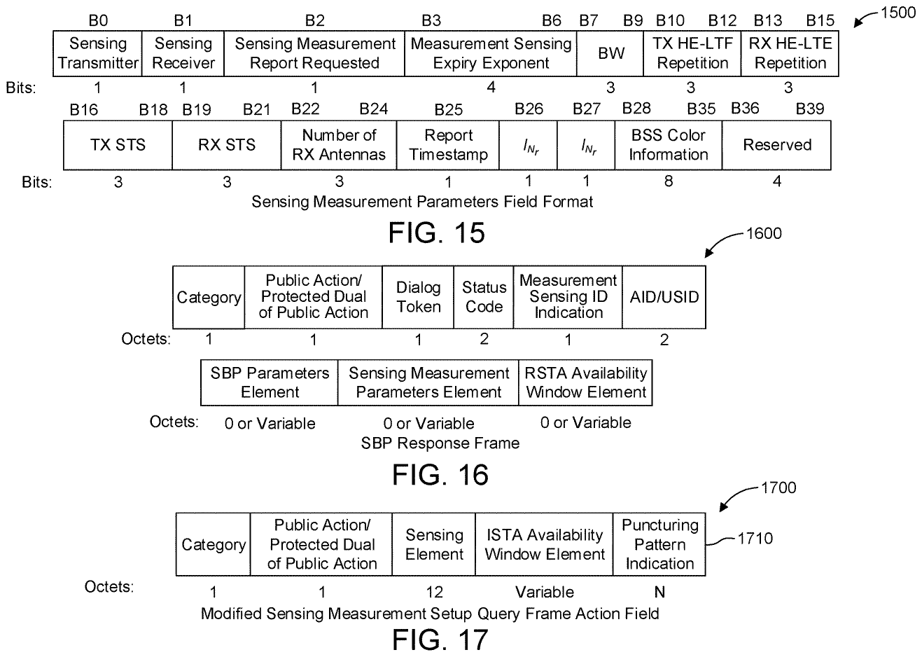

In other embodiments, procedures for sensing-by-proxy (SBP) are disclosed that allow a non-AP STA to request an AP to perform/coordinate sensing on its behalf. Referring to FIG. 11, in one example, the SBP initiator initiates a SBP procedure by transmitting an SBP Request frame 1100 to the SBP responder. On receiving the SBP Request frame 1100, the SBP responder may validate the frame and respond back with an SBP Response frame (an example of an SBP Response Frame 1600 is shown in FIG. 16). SBP Request frame 1100 may include an SBP Parameters element 1100 which includes sensing information for proxy STAs. FIG. 12 shows an example of an SBP Parameters element format 1210, which may include an SBP Parameters Control field 1210 and/or other fields as shown. FIG. 13 shows an example of an SBP Parameters Control field format 1310 and possible associated parameters as indicated.

Example Procedures for Enhanced Punctured Sensing with Unassociated STAs (U-STAs) are described. Various embodiments for an Enhanced frame for indicating a punctured pattern are also disclosed. In various embodiments, there are multiple options for an U-STA to include its puncturing pattern in a frame or element.

In one embodiment, the puncturing pattern may be included in the Sensing Measurement Setup Query frame. For example, a Puncturing Pattern Indication field in the Sensing Measurement Setup Query frame may indicate the puncturing pattern of an unassociated STA. FIG. 17 depicts an example of a Modified Sensing Measurement Setup Query frame Action field 1700 included in the Sensing Measurement Setup Query frame. In this example, a Puncturing Pattern Indication field 1710 may contain N octets. In one example for N=1, the 8-bits indicate the puncturing pattern of an unassociated STA, e.g., 1x111111 represents the 2nd 40 MHz subband is punctured and all remaining subbands are non-punctured in the 320 MHz operating channel of the unassociated STA.

Additionally, one bit in the Puncturing Pattern Indication field, or any other field of the Sensing Measurement Setup Query frame, may be used to indicate if the puncturing pattern is present in the frame or not. For example, if this bit is =1, it may imply that the puncturing pattern of the unassociated STA may be present in the frame it transmits; otherwise, it may not be present. Note that the bit used to indicate the presence of the puncturing pattern indication and/or the field or subfield to indicate the puncturing pattern may be present in any type of management, control, or action frame that the STA transmits.

Alternatively, one bit in the Sensing element may be used to indicate the Puncturing Pattern Indication field is present or not in the frame carrying the Sensing element. For example, if the bit in the Sensing element is set=1, it indicates the presence of Puncturing Pattern Indication field in the frame carrying this Sensing element, i.e., Modified Sensing Measurement Setup Query frame 1700 of FIG. 17 in this case; otherwise, the Puncturing Pattern Indication subfield 1710 is not present, e.g., the frame may be a legacy Sensing Measurement Setup Query frame Action field.

The puncturing pattern may be included in the Sensing field of the Sensing element. For example, the length of the Sensing element may be increased to at least 13-Octets. The Puncturing Pattern Indication field in the Sensing element may contain 8-bits with each bit indicating if the corresponding 40 MHz subband (i.e., one bit corresponds to one 40 MHz subband) is punctured or not for an unassociated STA operating in 320 MHz.

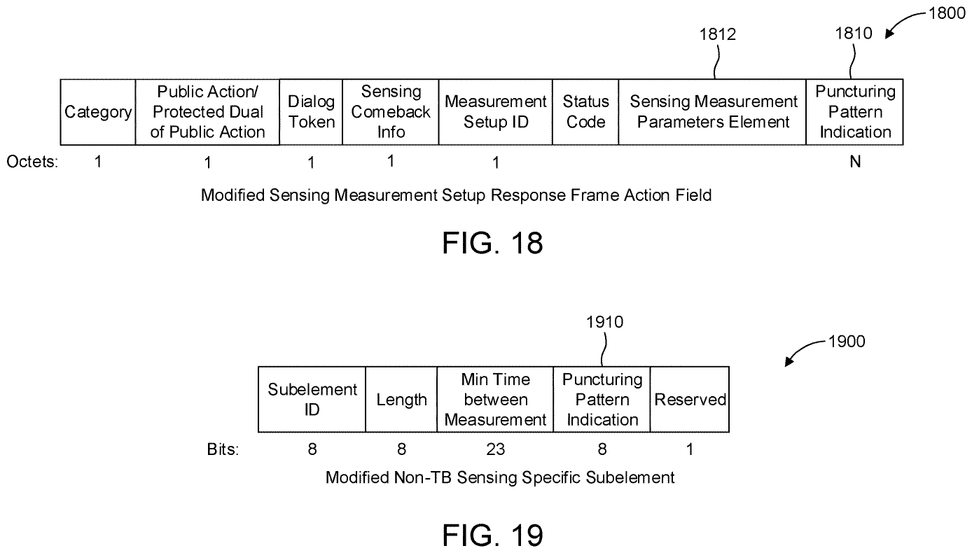

In one example embodiment, the puncturing pattern may be included in the Sensing Measurement Setup Response frame. For example, the Puncturing Pattern Indication field in the Sensing Measurement Setup Response frame may indicate the puncturing pattern of an unassociated STA. FIG. 18 depicts an example of a Modified Sensing Measurement Setup Response frame Action field 1800. In this example, a Puncturing Pattern Indication field 1810 may contain N octets, where N=1. The 8-bits indicate the puncturing pattern of an unassociated STA, e.g., 1x111111 presents the 2nd 40 MHz subband is punctured and all remaining subbands are non-punctured in the 320 MHz operating channel of the unassociated STA.

As an alternate option, one bit in the Sensing Measurement Parameters element, e.g., element 1812 of Action field 1800, may be used to indicate the Puncturing Pattern Indication field 1810 is present or not in the frame carrying the Sensing Measurement Parameters Element. For example, if the bit in the Sensing Measurement Parameters element 1812 is set=1, it indicates the presence of a Puncturing Pattern Indication field 1810 in the frame carrying this Sensing Measurement Parameters element, i.e., Modified Sensing Measurement Setup Response frame 1800 in this case. Otherwise, the Puncturing Pattern Indication subfield 1810 is not present, e.g., the frame may be a legacy Sensing Measurement Setup Response frame Action field.

In some embodiments, this enhancement for puncturing patter indication is applicable to the modified Sensing Measurement Setup Request frame. For example, the puncturing pattern may be included in the Sensing Measurement parameters field of the Sensing Measurement Parameters Element in a non-TB Sensing Measurement Setup, if it is initiated by an associated STA or an unassociated STA. For example, the length of the Sensing Measurement Parameters field of the Sensing Measure Parameters element may need to be increased to at least 6-Octets. The Puncturing Pattern Indication field in the Sensing Measurement parameters field may contain 8-bits with each bit indicating if the 40 MHz subband corresponding to the bit is punctured or not for an unassociated STA operating in 320 MHz.

In certain example embodiments, a puncturing pattern may be included in a Non-TB Sensing Specific sub element of the Sensing Measurement Parameters Element in the non-TB Sensing Measurement Setup, if it is initiated by an associated STA. Referring to FIG. 19, a Puncturing Pattern Indication field 1910 may be included in the Non-TB Sensing sub element 1900, which uses 8-bits to show the puncturing pattern of an unassociated STA. Each bit may correspond to a 40 MHz subband if the unassociated STA operates on 320 MHz channel.

In certain embodiments, an additional element/field/subfield may be included in the Sensing Measurement Setup Query frame. In one example, the Sensing Measurement Setup Query frame may include a Channel Switch Wrapper element and/or Channel Bandwidth Indication element, which are defined in 802.11be.

Procedures for Sensing Measurement Setup in the TB or non-TB sensing measurement instance: In one embodiment, the sensing measurement setup procedure with an unassociated STA in the TB sensing measurement may need to include the modified Sensing Measurement Request frame or/and the modified Sensing Setup Response frame sent from the unassociated STA.

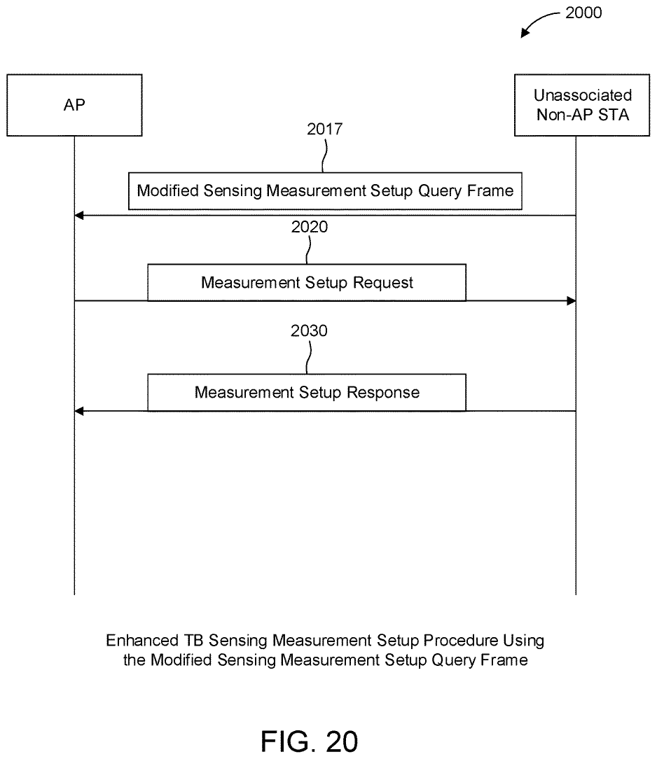

FIG. 20 depicts an example of an enhanced TB sensing measurement setup procedure 2000 using the Modified Sensing Measurement Setup Query frame 2017 (e.g., similar to 1700 of FIG. 17). In this example, an unassociated non-AP STA intends to participate in a sensing measurement setup initiated by an AP, and may send a Modified Sensing Measurement Setup Query frame 2017 which may include the punctured subchannel/subband information of the unassociated STA. After receiving the modified Sensing Measurement Setup Query frame 2017, the AP has the knowledge of the punctured subchannel/subband of the unassociated non-AP STA. The AP may then transmit the Measurement Setup Request frame 2020 and the unassociated non-AP STA responds with the Measurement Setup Response frame 2030. If the unassociated non-AP STA is the sensing receiver and the sensing measurement report is required by the AP, the AP may not request the unassociated non-AP STA to send the sensing measurement report on the punctured subchannel/subband indicated by the unassociated non-AP STA in query frame 2017.

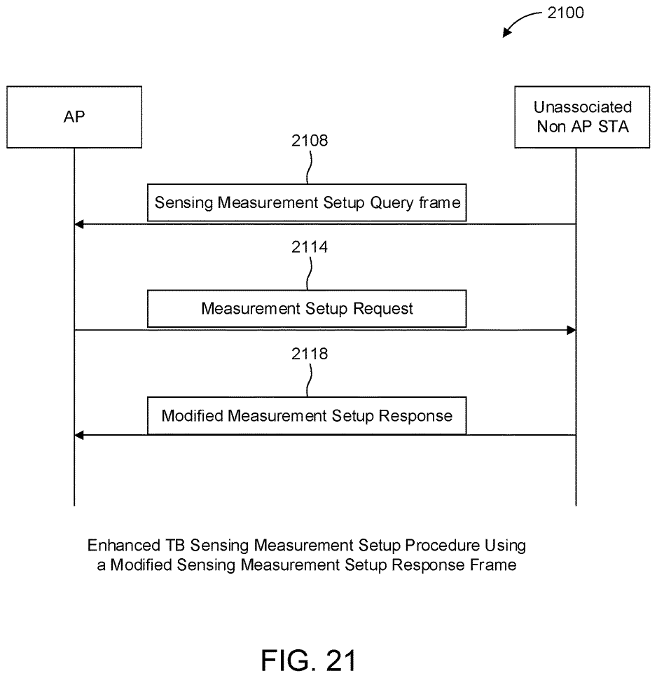

In an alternative embodiment, an unassociated non-AP STA may indicate its punctured subchannel of subband in the Modified Measurement Setup Response frame after reception of the Measurement Setup Request frame from the AP in the TB sensing measurement setup procedure. FIG. 21 depicts an example of the enhanced TB sensing measurement setup procedure 2100 using a Modified Sensing Measurement Response frame 2118. In this example, an unassociated non-AP sends the Sensing Measurement Setup Query frame 2108 (e.g., similar to frame 800 of FIG. 8) to indicate its intension to participate in the sensing measurement setup initiated by an AP. Subsequently, the AP transmits the Sensing Measurement Setup Request frame 2114 and the unassociated non-AP STA responds with the Modified Measurement Setup Response frame 2118, which may include the punctured subchannel/subband information of the unassociated non-AP STA.

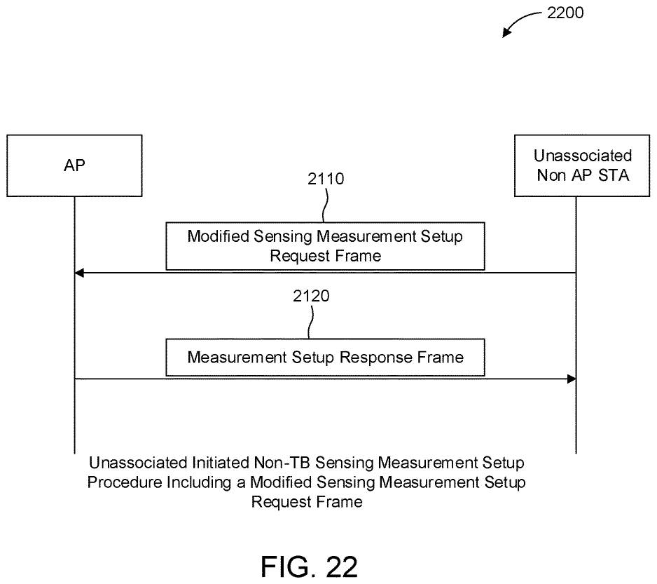

In one embodiment, in the sensing measurement setup initiated by an unassociated non-AP STA, the non-AP STA may transmit a Modified Sensing Measurement Setup Request frame, which may include the punctured subchannel/subband information of the unassociated non-AP STA. FIG. 22 shows an example of the unassociated STA initiated non-TB sensing measurement setup procedure 2200 using a Modified Sensing Measurement Setup Request frame. In this example, the Modified Sensing Measurement Setup Request frame 2110 sent by the non-AP U-STA may include the punctured subchannel/subband information of the unassociated non-AP STA and the AP responds with the Sensing Measurement Setup Response frame 2120 after receiving the Modified Sensing Measurement Setup Request frame 2110 from the unassociated non-AP STA.

If the AP receives a frame from a STA and the frame includes the puncturing pattern information of the STA, such as the bit used to indicate the presence of the puncturing pattern in the frame is equal to true and/or the STA's puncturing pattern is included, then the AP may not assign to the STA any punctured resource unit (RU) that this STA has indicated. For example, in the Polling phase, Trigger frame Sounding phase, and/or the Reporting phase, the AP may not assign the STA an RU or multiple RU (MRU) which includes any of the punctured subchannel(s) as indicated by the STA in the punctured channel information. Additionally, the AP may transmit a DL null-data packet (NDP) on the subchannels which are not indicated as the punctured subchannels by the recipient of the DL NDP, e.g., the unassociated STAs.

Embodiments for a procedure of UL Sounding with Puncturing are also disclosed. For example, an UL NDP Indication may be used. In one embodiment, if an AP receives a frame from an STA and the frame includes the puncturing pattern information of the STA, such as the bit used to indicate the presence of the puncturing pattern in the frame is equal to true and/or the STA's puncturing pattern is included, then the AP may request the STA, e.g., unassociated STA, to transmit a NDP on the UL channels which do not include the punctured subchannel(s) that the STA indicates. The sensing AP may indicate the NDP bandwidth in the UL BW subfield of the common field of the high efficiency (HE) or extremely high throughput (EHT) variant Common Info field. Alternatively, the UL NDP bandwidth may be included in any frame, e.g., control frame or management frame the AP transmits to the unassociated STA. The NDP bandwidth may cover the primary channel of the sensing AP. Note that the puncturing pattern information of the unassociated STA may include the puncturing pattern information indicated by a neighboring BSS, e.g., with which the unassociated STA is associated, and additional subchannels, if any, that the STA may puncture.

Alternatively, the AP may request the unassociated STAs to transmit the NDP on the channels on which the AP operates. In this case, the unassociated STAs may transmit the NDP based on its own punctured subchannel pattern. For example, the STA may only transmit the NDP on contiguous non-punctured subchannels. Alternatively, with or without knowledge of the puncturing pattern in the sensing AP, the unassociated STA may transmit an UL NDP with punctured subchannel(s). In some embodiments, the AP may use non-HT duplicated PPDU to transmit the Sensing Responder to Sensing Initiator (SR2SI) Sounding Trigger frame to solicit the NDP transmission from non-AP STAs.

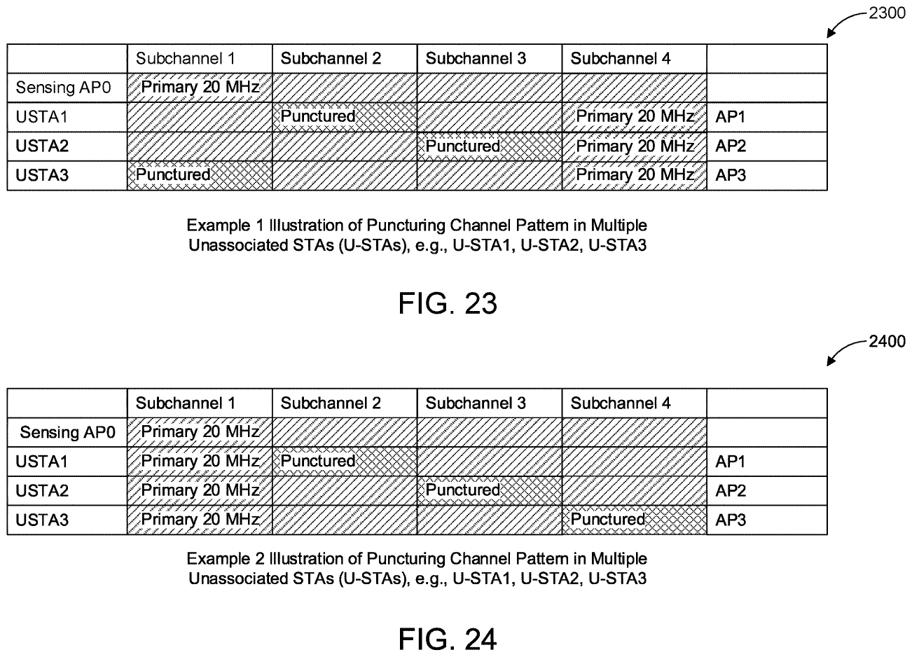

FIG. 23 shows an exemplary illustration of puncturing channel pattern 2300 in multiple unassociated STAs (U-STAs). In this example, three unassociated STAs, i.e., U-STA1, U-STA2 and U-STA3, are associated with AP1, AP2 and AP3 respectively. Sensing AP0 operates on 80 MHz BW which contains non-punctured subchannel-1, subchannel-2, subchannel-3 and subchannel-4. Subchannel-1 is the primary 20 MHz subchannel of sensing AP0; Subchannel-4 is the primary 20 MHz channel of AP1, AP2 and AP3. Subchannel-2, Subchannel-3 and Subchannel-1 are indicated as the punctured subchannel by U-STA1, U-STA2 and U-STA3 respectively. In order to solicit the UL NDP from any or all of the non-AP STAs U-STA1, U-STA2 and U-STA3, sensing AP0 may transmit the SR2SI Sounding Trigger frame using non-HT DUP PPDU format.

FIG. 23 Example Case 1: If Sensing AP0 solicits an NDP from U-STA1 only, Sensing AP0 may indicate 20 MHz BW in the UL BW subfield of the HE/EHT Trigger frame common field and request the UL NDP transmission on subchannel-1 only.

FIG. 23 Example Case 2: If Sensing AP0 solicits an NDP from U-STA2 only, Sensing AP0 may indicate 40 MHz BW in the UL BW subfield of the HE/EHT Trigger frame common field and request the UL NDP transmission on subchannel-1 and subchannel-2.

FIG. 23 Example Case 3: If Sensing AP0 has the puncturing pattern information of U-STA3, then Sensing AP0 may not request an UL NDP from U-STA3, because AP0's primary 20 MHz channel is punctured by U-STA3.

In any case, Sensing AP0 may solicit a NDP from U-STA1 and/or U-STA2 and/or U-STA3, which covers subchannel-1 to subchannel-4. The unassociated STAs may decide not to transmit a NDP if any punctured subchannel is present in the requested NDP transmission.

FIG. 24 shows a second example of a puncturing channel pattern 2400 with multiple unassociated STAs (U-STAs). In this second example, three unassociated STAs, i.e., U-STA1, U-STA2 and U-STA3, are associated with AP1, AP2 and AP3 respectively. Sensing AP0 operates on 80 MHz BW which contains unpunctured subchannel-1, subchannel-2, subchannel-3 and subchannel-4. AP0, AP1, AP2 and AP3 have the same primary 20 MHz subchannel, i.e., subchannel 1. Subchannel-2, subchannel-3 and subchannel-4 are indicated as the punctured subchannels in U-STA1, U-STA2 and U-STA3 respectively. In this scenario, sensing AP0 may transmit the SR2SI Sounding Trigger frame using a non-HT DUP PPDU format to solicit the UL NDP from any of U-STA1, U-STA2 or/and U-STA3.

FIG. 24 Example Case 1: If Sensing AP0 solicits a NDP from U-STA1 only, Sensing AP0 may indicate 20 MHz BW in the UL BW subfield of the HE/EHT Trigger frame common field and request the UL NDP transmission on subchannel-1 only, because subchannel-2 is punctured by U-STA1.

FIG. 24 Example Case 2: If Sensing AP0 solicits a NDP from U-STA2 only, Sensing AP0 may indicate 40 MHz BW in the UL BW subfield of the HE/EHT Trigger frame common field and request the UL NDP transmission on subchannel-1 and subchannel-2.

FIG. 24 Example Case 3: If Sensing AP0 solicits a NDP from U-STA3 only, Sensing AP0 may indicate 40 MHz BW in the UL BW subfield of the HE/EHT Trigger frame common field and request the UL NDP transmission on subchannel-1 and subchannel-2.

In any case, Sensing AP0 may solicit NDP from U-STA1 and/or U-STA2 and/or U-STA3 which covers subchannel-1 to subchannel-4. The unassociated STA may decide not to transmit the NDP if any punctured subchannel is present in the requested NDP transmission.

In the case where the sensing AP indicates the UL NDP which covers the non-punctured subchannels indicated by the AP and includes the punctured subchannel(s) the unassociated STA may indicate, the unassociated STA may transmit an UL NDP with punctured subchannel(s) that are indicated by its serving BSS and/or the additional subchannels which the STA punctures. If the AP only receives a NDP with a partial bandwidth from a U-STA, i.e., the received NDP bandwidth is smaller than the requested NDP, the AP may use the received NDP bandwidth to determine the actual operating bandwidth of this U-STA. Consequently, the AP may allocate only the channels within the operating bandwidth of this U-STA to this U-STA. For example, if U-STA1 transmits the NDP on subchannel-1 only, AP0 may only allocate subchannel-1 to U-STA1 to transmit the sensing results if U-STA1 is also the sensing receiver and the sensing reports are required. If U-STA1 transmits the NDP on subchannel-3 and subchannel-4, AP0 may only allocate subchannel-3 and/or subchannel-4 to U-STA1 to transmit the sensing results if U-STA1 is also the sensing receiver and the sensing reports are required.

Similar rules may be applicable to the resource allocation in the polling phase. If the AP has the knowledge of the puncturing information of the unassociated STAs through any of the methods mentioned herein, then the AP may only allocate the non-punctured subchannel(s) indicated by the STA to transmit this STA's CTS-to-Self frame. For example, in FIG. 23 if AP0 knows subchannel-2 is indicated as the punctured subchannel by U-STA1, AP0 may allocate subchannel-1, subchannel-3 and/or subchannel-4 to transmit CTS-to-Self frame in the polling phase. Alternatively, if AP0 receives the NDP frame from U-STA1 on subchannel-3 and subchannel-4, AP0 may only allocate subchannel-3 and/or subchannel-4 to the U-STA to respond with a CTS-to-Self frame in the future polling phase.

Embodiments for an Enhanced SR2SI Sounding Trigger frame are also disclosed. In one embodiment, the NDP Resource Allocation subfield is added to the User Info field for the SR2SI Sounding Trigger frame. The NDP Resource Allocation subfield may include the information where the UL NDP bandwidth starts and/or the UL NDP bandwidth ends. Additionally, or alternatively, the NDP Resource Allocation subfield may include the Resource Units (RUs) that the UL NDP may cover.

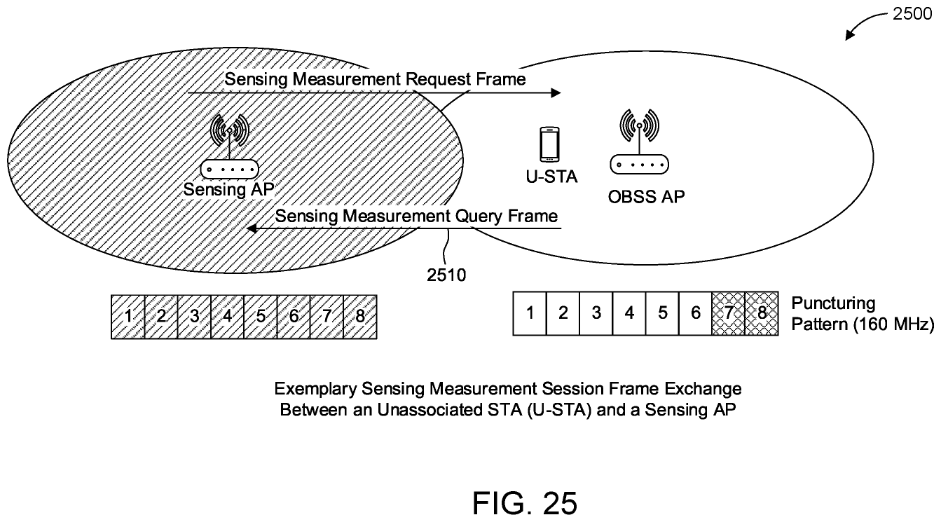

According to some embodiments, a procedure for Channel Information Exchange in Sensing Measurement Session with Unassociated STAs is disclosed. Referring to FIG. 25, an example method 2500 for Sensing Measurement Session Frame Exchange Between an Unassociated STA (U-STA) and a Sensing AP is shown. In one embodiment, an unassociated STA may choose to participate in a sensing measurement session setup with a sensing AP in cases when it receives the Neighbor Report element or the Reduced Neighbor Report element from its own AP with the information required for successful sensing operation with the sensing AP. The information may include the operation channel width, channel number, primary channel and disabled subchannel bitmap of the sensing AP. The unassociated STA may use the channel information shared in the Neighbor Report element or the Reduced Neighbor Report element to decide if the participation in the sensing measurement session with the sensing AP may violate the operation and the transmission requirements in its own AP or not. The unassociated STA may choose to send the Sensing Measurement Query frame 2510 to the sensing AP to share its sensing capabilities, declare its presence and participate in the sensing measurement session when the sensing operation will not violate the operation in its own AP as depicted in FIG. 25.

In one embodiment, an unassociated STA may participate in the sensing measurement session with a sensing AP if the unassociated STA and the sensing AP use the same primary channel, otherwise the unassociated STA shall refrain from participating in the sensing measurement session with the sensing AP.

In one embodiment, an unassociated STA may participate in the sensing measurement session with a sensing AP if the unassociated STA and the sensing AP use the same puncturing pattern, otherwise the unassociated STA shall refrain from participating in the sensing measurement session with the sensing AP.

In one embodiment, the unassociated STA may include channel information in the Sensing Measurement Query frame (e.g., sent frame 2510 of FIG. 25) it sends to the sensing AP. The channel information may include channel number, the operation channel width, and indication of the primary channel and a disabled channel bitmap. The sensing AP may use the channel information of the unassociated STA to schedule sensing resources for the unassociated STA that does not violate the transmission requirements in its own BSS. The sensing resources may include the resource allocation for the polling phase, the resource allocation for the trigger frame (TF) sounding phase, and the resource allocation for the reporting phase.

In one embodiment, the unassociated STA may use the channel information of the sensing AP which includes the operation channel width, the channel number, the primary channel, and the primary/secondary 80 MHz to locate the physical allocated RU relative to the sensing AP.

In one embodiment, the unassociated STA may send the Sensing Measurement Query frame using the non-HT duplicate PPDU. In another method, the unassociated STA may use the overlapping subchannels of its own BSS and the BSS of the sensing AP to send the Sensing Measurement Query frame.

In other embodiments, an Enhanced Early Announcement of Availability for non-AP STA to Participate in TB or non-TB Sensing are disclosed. An AP may use the Sensing element to announce the need for new responders in the Beacon frame, the Probe Response frame, or the (Re) Association Response frame by setting the Responders Needed subfield within the Sensing field in the Sensing element=1. Note, the Responders Needed subfield may have a different name or size to enable the behavior described in this embodiment. Furthermore, another subfield may be defined besides the Responders Needed subfield (for example, named as non-TB Sensing) to enable the behavior described in this embodiment.

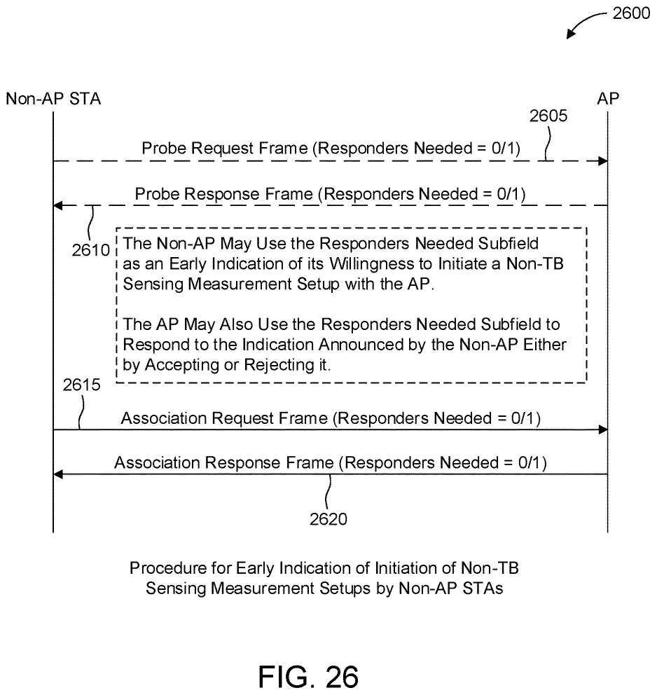

Referring to FIG. 26, a method 2600 is disclosed for early indication of initiation of a non-TB sensing measurement setup by a non-AP STA. Generally, in trigger-based (TB) sensing measurement instance, the sensing initiator is an AP and one or more STAs have the role of sensing responders. In a non-TB sensing measurement instance, the sensing initiator is a client/STA and only one STA (an AP) assumes the role of sensing responder. In embodiments for non-TB Sensing, a non-AP STA may use a Responders Needed subfield (or any other subfield designated for this purpose) within the Sensing subfield in the Sensing element transmitted in a Probe Request frame 2605 to the AP for early indication if a non-TB sensing measurement setup may be initiated with the AP. The AP receiving this Probe Request frame 2605 is shown in FIG. 26. The non-AP STA may set the Responders Needed subfield (or any other subfield designated for this purpose)=1 to indicate that the STA may initiate a non-TB sensing measurement setup and set=0 to indicate the STA may not initiate a non-TB sensing measurement setup with the AP. The AP may decide to go in a doze mode to save power if all the non-AP STAs indicate that they may not initiate a non-TB sensing measurement setup with the AP. The AP may manage its resources in different ways depending on the early indications received from the non-AP regarding the potential initiation of non-TB measurement setups.

The AP STA may respond in the Probe Response frame 2610 to the early indication announced by the non-AP STA in different ways as listed in Table 1 below. The AP may set the Responders Needed subfield (or any other subfield designated for this purpose)=1 to indicate that it is available to participate as a Responder in a non-TB sensing measurement setup initiated by the non-AP STA. The AP may set the Responders Needed subfield (or any other subfield designated for this purpose)=0 to indicate that it is not available to participate as a Responder in a non-TB sensing measurement setup initiated by the non-AP STA.

TABLE 1
Example behavior of non-AP STA and AP STA according
to the setting of the Responders Needed subfield
(non-TB Sensing Measurement Setup)

| | Responders Needed = 1 | Responders Needed = 0 |
|---|---|---|
| Non-AP | The non-AP STA is willing to | The non-AP STA is not willing |
| STA | initiate a non-TB sensing | to initiate a non-TB sensing |
| | measurement setup with | measurement setup with |
| | this AP. | this AP. |
| AP | The AP is available to | The AP is not available to |
| | participate as a sensing | participate as a sensing |
| | Responder in a non-TB | Responder in a non-TB sensing |
| | sensing measurement setup | measurement setup |

As shown in FIG. 26, the Responder Needed subfield may, alternatively or in addition, be exchanged in an (re) association request frame 2615 and/or (re) association response frame 2620.

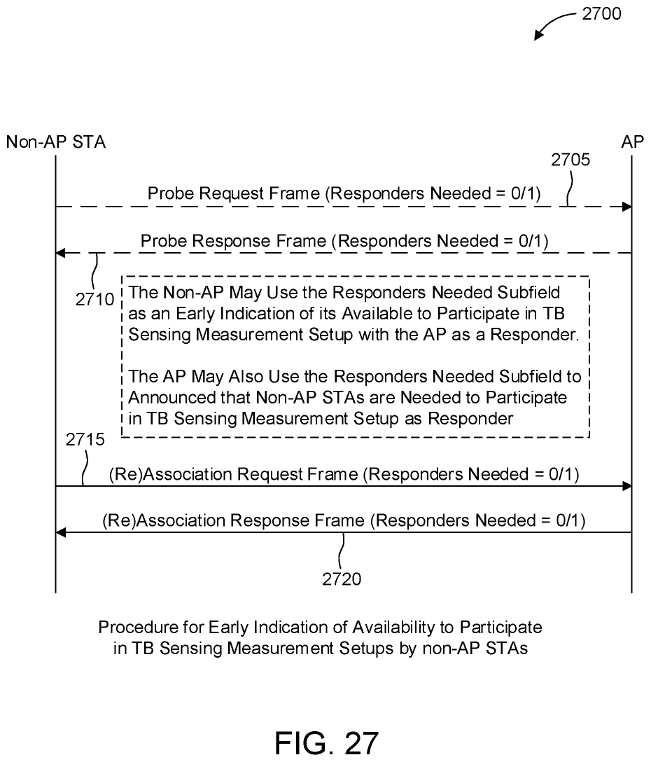

Referring to FIG. 27, in another method 2700 for TB sensing, a non-AP STA may use the Responders Needed subfield (or any other subfield designated for this purpose) within the Sensing subfield in the Sensing element it transmits in a Probe Request frame 2705 to early indicate if it may or may not participate in a TB sensing measurement setup with the AP receiving this Probe Request frame. The non-AP may set the Responders Needed subfield (or any other subfield designated for this purpose)=1 to indicate that it is available to participate in TB sensing measurement setups as a Responder or set=0 to indicate it is not available to participate in TB sensing measurement setups as a Responder with the AP. Thereafter, the AP may decide not to initiate a TB sensing measurement setup with this non-AP STA until it indicates its availability to participate in TB sensing measurement setups as a Responder in a later association or reassociation.

In some embodiments, the AP STA may respond in a Probe Response frame 2710 to the early indication announced by the non-AP STA in different ways as listed in Table 2 below. The AP may set the Responders Needed subfield (or any other subfield designated for this purpose)=1 to indicate that the non-AP STA receiving this Probe Response 2710 is needed to participate in TB sensing measurement setups. The AP may set the Responders Needed subfield (or any other subfield designated for this purpose)=0 to indicate that the non-AP STA receiving this Probe Response 2710 is not needed to participate in TB sensing measurement setups.

TABLE 2
Example behavior of non-AP STA and AP STA according
to the setting of the Responders Needed subfield
(TB Sensing Measurement Setup)

| | Responders Needed = 1 | Responders Needed = 0 |
|---|---|---|
| Non-AP | The non-AP STA is willing to | The non-AP STA is not willing |
| STA | participate in TB sensing | to participate in TB sensing |
| | measurement setups with | measurement setups with |
| | this AP as a Responder. | this AP as a Responder. |
| AP | The AP is announcing that | The AP is announcing that |
| | non-AP STAs are needed to | non-AP STAs are not needed to |
| | participate as sensing | participate as sensing |
| | Responders in TB sensing | Responders in TB sensing |
| | measurement setups | measurement setups |

In one embodiment, the non-AP STA may set the Responders Needed subfield (or any other subfield designated for this purpose) in the subsequent Association Request frame or the subsequent Reassociation Request frame 2715 in a similar way as with the Probe Request frame 2705. In some cases, the non-AP STA may set the subfield differently to indicate a change in the behavior. Accordingly, the AP may set the Responders Needed subfield (or any other subfield designated for this purpose) in the Association Response frame or the Reassociation Response frame 2720 in a similar way as in the Probe Response frame 2710, or it may set the subfield differently to indicate a change in the response to the non-AP STA behavior.

Enhanced Operation for TB and non-TB Sensing: In one embodiment the Responders Needed subfield (or any other subfield designated for this purpose) size may be expanded. In one example, as listed in Table 3 below, a 2-bit encoding of this subfield may be used by the non-AP to indicate its willingness to initiate a non-TB sensing measurement setup with the AP and/or its availability to participate in TB sensing measurement setups with the AP as a Responder. This 2-bit encoding may be used also by the AP to indicate its availability to participate in non-TB sensing measurement setups initiated by the non-AP STA and the need for Responders to participate in TB sensing measurement setups.

TABLE 3
Example behavior of non-AP STA and AP STA according to the
setting of the Responders Needed subfield (2-bit Encoding)

| Responders | | |
|---|---|---|
| Needed | Interpretation if set in a frame sent by | Interpretation if set in a frame |
| subfield value | the non-AP STA | sent by the AP |
| 00 | Non-AP is not willing to initiate non-TB sensing | AP is not available to participate in non-TB |
| | measurement setups. | sensing measurement setups. |
| | Non-AP is not available to participate as a | AP is not inviting Responders to participate |
| | Responder in TB sensing measurement setups. | in TB sensing measurement setups. |
| 01 | Non-AP is willing to initiate non-TB sensing | AP is available to participate in non-TB |
| | measurement setups. | sensing measurement setups. |
| | Non-AP is not available to participate as a | AP is not inviting Responders to participate |
| | Responder in TB sensing measurement setups. | in TB sensing measurement setups. |
| 10 | Non-AP is not willing to initiate non-TB sensing | AP is not available to participate in non-TB |
| | measurement setups. | sensing measurement setups. |
| | Non-AP is available to participate as a Responder | AP is inviting Responders to participate in |
| | in TB sensing measurement setups. | TB sensing measurement setups. |
| 11 | Non-AP is willing to initiate non-TB sensing | AP is available to participate in non-TB |
| | measurement setups. | sensing measurement setups. |
| | Non-AP is available to participate as a Responder | AP is inviting Responders to participate in |
| | in TB sensing measurement setups. | TB sensing measurement setups. |

Transmitter Behavior: In one embodiment, if the non-AP STA is the transmitter of the frame containing the Responders Needed subfield (or any other subfield designated for this purpose), the non-AP STA may use this subfield to announce early indication of its availability for different types of sensing measurement setups (e.g., TB and non-TB). The non-AP STA may use this subfield to inform the AP whether it may initiate non-TB sensing session with the AP, and consequently the AP may manage its resources differently. The AP may also decide to go in a doze mode to save power in case there are no non-TB sensing measurement setups expected. The non-AP STA may also use this field to indicate that it is not available temporarily to participate in TB sensing measurement setups initiated by the AP such that the AP may not send a Sensing Measurement Setup Request frame to this non-AP which may save time, energy, and resources and make the sensing operation more efficient.

In one embodiment, if the AP is the transmitter of the frame containing the Responders Needed subfield (or any other subfield designated for this purpose), the AP may use this subfield to announce that it is not available temporarily to participate in non-TB sensing measurement setup. The AP may also use this subfield to announce that Responders are needed to participate in subsequent sensing measurement setups.

Receiver Behavior: In one embodiment, if the non-AP STA is the receiver of the frame containing the Responders Needed subfield (or any other subfield designated for this purpose), the non-AP STA may refrain from sending Sensing Measurement Setup Request frames if the AP indicated that it is not available to participate in non-TB sensing measurement setups. The non-AP STA may also go in a doze mode if the AP indicates that it is not inviting Responders to participate in TB sensing measurement setups.

In one embodiment, if the AP is the receiver of the frame containing the Responders Needed subfield (or any other subfield designated for this purpose), the AP may manage its resources differently and/or the AP may also decide to go in a doze mode to save power in case there are no non-TB sensing measurement setups expected. Also, the AP may refrain from sending Sensing Measurement Setup Request frames to this non-AP STA which may save time, energy, and resources and make the sensing operation more efficient.

Certain embodiments relate to procedures to terminate unsuccessfully completed sensing measurement setup with unassociated STAs. In one embodiment, a sensing initiator AP shall assign a measurement setup ID (MSID) value to the sensing measurement setup initiated with an unassociated non-AP STA in the first Sensing Measurement Setup Request frame sent by this sensing initiator AP to the unassociated non-AP STA as a response to receiving the first Sensing Measurement Setup Query frame sent by this unassociated non-AP STA to the sensing initiator AP.

In one embodiment, the sensing initiator AP may set the Comeback field in the Sensing Comeback Info field within the Sensing Measurement Setup Request frame=1 to request the unassociated non-AP STA to come back later to complete the sensing measurement setup. The sensing initiator AP may also set the Measurement Setup ID field in the Sensing Measurement Setup Request frame to the MSID value assigned in the previous embodiment.

The unassociated non-AP STA may respond to the request to come back later by sending the Sensing Measurement Setup Query frame again to the sensing initiator AP. The sensing initiator AP may request the unassociated STA to come back later several times before the AP can complete the sensing measurement setup.

In one embodiment, the sensing initiator AP may use the MSID value to terminate the sensing measurement setup later by sending a Sensing Measurement Setup Termination frame, with Measurement Setup ID field in the Sensing Measurement Setup Termination frame set to the MSID value. Referring back to FIG. 10, an example format of a Sensing Measurement Setup Termination frame 1000 is illustrated.

In one embodiment, the sensing initiator AP may terminate the sensing measurement setup in the case where the AP requested the unassociated STA to come back later to complete the sensing measurement setup and when the unassociated non-AP STA sent the Sensing Measurement Setup Query the AP was busy and not able to complete the sensing measurement setup.

In one embodiment, the sensing initiator AP may terminate the sensing measurement setup in the case where the AP requested the unassociated STA to come back later to complete the sensing measurement setup and the unassociated non-AP STA was not able to come back because of unforeseen reasons (e.g., handling a communication task).

In one embodiment, the sensing initiator AP may notify the unassociated non-AP STA not to establish the sensing measurement setup for different reasons. Examples of such reasons may be: a) the unassociated STA does not come back during a given amount of time after the AP indicates to the unassociated STA to come back later, e.g., setting the Comeback subfield=1; and/or b) the AP does not need the unassociated STA to perform sensing. In the mentioned cases and any other unforeseen cases, the AP may send the Sensing Measurement Setup Request frame to the unassociated STA by setting the Comeback subfield=0 and the Measurement Setup ID field to a specified value (e.g., all 1's in the Measurement Setup ID field) to indicate there is no need for the unassociated STA to perform sensing. Upon reception of the Sensing Measurement Setup Request frame with the Comeback subfield set=0 and the Measurement Setup ID field set to a specified value (e.g., all 1's), the unassociated STA may not send back the Sensing Measurement Setup Response frame. In other words, the sensing measurement setup between the AP and this unassociated STA is unestablished or/and terminated.

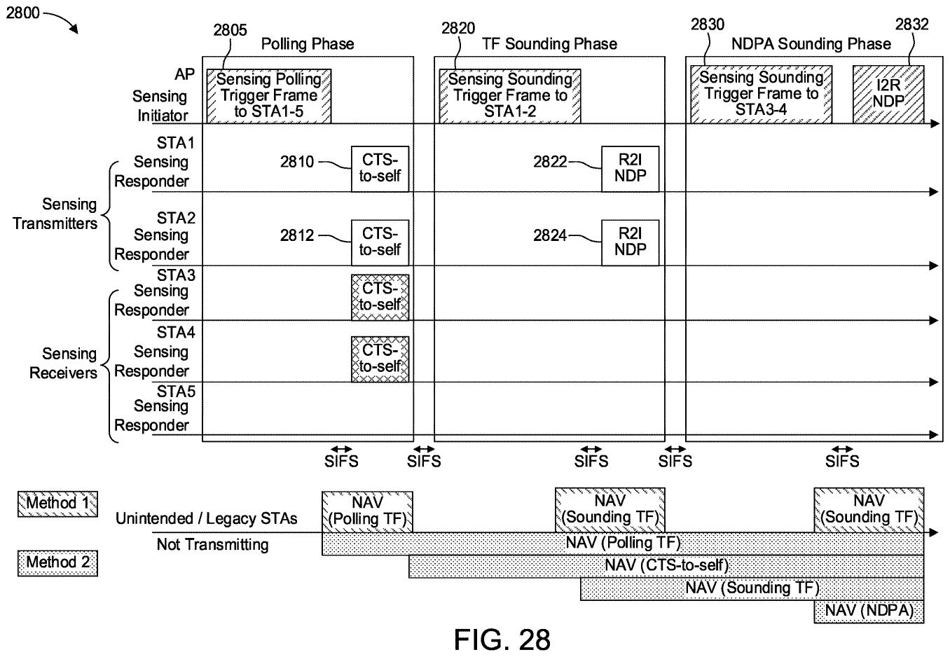

Turning to FIG. 28, a method 2800 to truncate a Sensing transmission opportunity (TXOP) according to various embodiments is shown. An example of a TB sensing measurement exchange is shown in FIG. 28. The Duration/ID fields of each frame transmitted in the frame exchange sequence may be used to set the network allocation vector (NAV) for unintended STAs. In the example shown, STA1 and STA 2 are sensing transmitters and STA3, STA4 and STA5 are sensing receivers.

In one method, the initial frame of each phase, e.g., the Sensing Polling Trigger frame 2805 in the Polling phase, the Sensing Sounding Trigger frame 2820 in TF Sounding phase, or the Sensing NDP announcement (NDPA) frame 2830 in NDPA Sounding phase, may be used to reserve the medium to permit completion of the current phase. For example, the sensing initiator may set the Duration/ID field in the initial frames to a value of the estimated transmit time of the response frame and/or a certain interframe space (IFS) (e.g., one or two SIFs).

In one method, the initial frame of one or more phases may be used to reserve the medium to permit completion of the entire sensing measurement exchange. For example, the Duration/ID field in the Sensing Polling Trigger frame 2805 may be set to cover the transmission time of the responder STA's CTS-to-self frame 2810, 2812, the TF Sounding phase, the NDPA Sounding phase and any necessary IFS.

In another example, the Duration/ID field in the Sensing Sounding Trigger frame 2820 may be set to cover the transmission time of the responder to initiator (R2I) NDP frame 2822, 2824, the NDPA Sounding phase and any necessary IFS. In yet another example, the Duration/ID field in the Sensing NDPA frame 2830 may be set to cover the transmission time of the initiator to responder (I2R) NDP frame 2832 and any necessary IFS.

In one method, a STA that used information from one or more initial frames as the most recent basis to update its NAV setting may be permitted to reset its NAV if no PHY-RXEARLYSIG.indication or PHYRXSTART. indication primitive is received from the PHY during a NAVTimeout period starting when the MAC receives a PHY-RXEND.indication primitive corresponding to the detection of the initial frame.

In one method, a STA that used information from one or more initial frames as the most recent basis to update its NAV setting may NOT be permitted to reset its NAV if no PHY-RXEARLYSIG.indication or PHYRXSTART. indication primitive is received from the PHY during a NAVTimeout period starting when the MAC receives a PHY-RXEND.indication primitive corresponding to the detection of the initial frame unless the STA may receive a contention free end (CF_End) frame (or other frame/field with an indication that the sensing TXOP is truncated) from the sensing initiator.

According to some embodiments, the sensing initiator may truncate the TXOP if it may not receive any response or enough response from the sensing responders. The sensing initiator may transmit a frame, or a frame with a field/subfield, to indicate the sensing TXOP is truncated and the unintended STAs may update their NAV setting to 0.

For one embodiment, the TXOP is truncated by the sensing initiator sending a CF-end frame. In another option, the sensing initiator may send a frame which may carry an RDG/More PPDU field/subfield to indicate no more PPDUs in the TXOP. For example, a RDG/More PPDU field in a QoS Null frame or a RDG/More PPDU field in HT Control field or A-Control field. The sensing initiator may also truncate the TXOP by sending a QoS Null frame with End Of Service Period (EOSP) field set to 1.

In one example, the initial frames 2805, 2820, 2830 may be transmitted using a non-HT Duplicate PPDU to protect the TXOP. For one example method, the Sensing Polling Trigger 2805 frame may allocate resource units (RUs) for the sensing responders to respond with CTS-to-Self frame(s) 2810, 2812. In order to enable legacy STAs to understand the CTS-to-self transmissions, the RU allocated to the sensing responders may have a minimum resolution of 20 MHz or a 242-tone RU. If a sensing responder is assigned a 242-tone RU, it may respond with the CTS-to-Self frame using a non-HT PPDU or non-HT duplicate PPDU. If a sensing responder is assigned a 484-tone RU (corresponding to 40 MHz subchannel) or above, it may respond the CTS-to-Self frame using a non-HT duplicate PPDU. In this way, a unintended legacy STA may detect the CTS-to-Self frame correctly and properly set its NAV. A sensing responder which receives the Sensing Polling Trigger frame 2805 addressed to it may consider the clear channel assessment (CCA) and/or NAV in determining whether to respond with the CTS-to-Self frame. In one example, a responder may not have a NAV on the assigned subchannel/RU, or the responder may have a NAV indicating idle on the primary 20 MHz channel, and it may respond with the CTS-to-Self frame if the CCA has been idle for the assigned subchannel/RU for a predefined time duration, e.g., a PIFS time.

On reception of the Sensing Polling Trigger frame 2805, the sensing responder may set the TXVECTOR parameters CH_BANDWIDTH and CH_BANDWIDTH_IN_NON_HT to the same value as the UL BW subfield in the Sensing Polling Trigger frame 2805 it received. The CTS-to-Self frame 2810, 2812 is carried in a non-HT or non-HT duplicate PPDU that may have a field/subfield to indicate the bandwidth. The field/subfield may be set to the same value in the TXVECTOR parameters CH_BANDWIDTH and/or CH_BANDWIDTH_IN_NON_HT. The CTS-to-Self frame is carried in a non-HT or non-HT duplicate PPDU that may be transmitted on a channel with channel bandwidth that is equal to or less than that indicated in the TXVECTOR parameters CH_BANDWIDTH and/or CH_BANDWIDTH_IN_NON_HT.

Embodiments to signal unavailability of unassociated STAs are disclosed. In one embodiment, a non-AP STA which is unassociated to a sensing AP (i.e., U-STA) may indicate that it is unavailable for data transmission with its serving AP, with which the STA is associated, during its sensing availability window. The non-AP STA may signal its unavailability during a period of time (such as the sensing availability window) by indicating this state in a signaling field (e.g., by setting this field to true or 1) in the MAC frame (e.g., Control, Management, and/or Data frames). The non-AP STA may then indicate that it is available for data transmission by setting the same field to another value (e.g., by setting this field to false or 0)

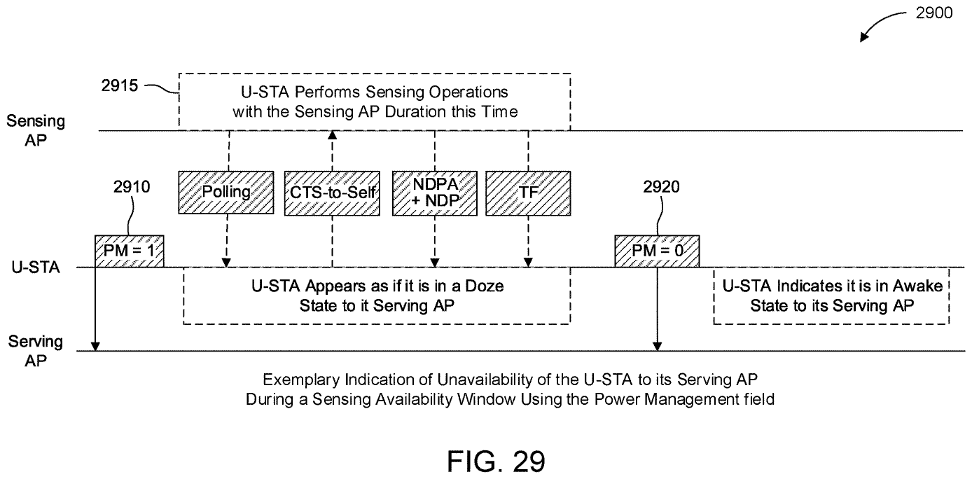

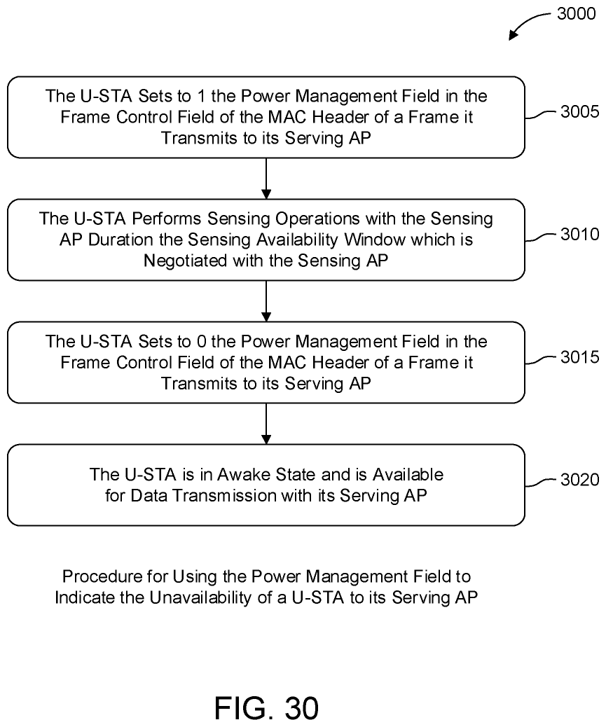

Referring to FIG. 29, an example frame exchange sequence diagram 2900 is shown for a non-AP STA to signal its unavailability for data transmission with its serving AP during a period of time by setting=1, the Power Management field (i.e., PM bit 2910) in the Frame Control field of the MAC header of a transmitted frame to its serving AP. The U-STA performs sensing operations with the sensing AP during a sensing window 2915. The U-STA may then indicate its availability for data transmission with its serving AP by setting=0 the Power Management field 2920 in the Frame Control field of the MAC header of a transmitted frame to its serving AP. An example of this behavior is illustrated in the frame exchange sequence in FIG. 29. FIG. 30, shows a corresponding method 3000 for a sensing U-STA to indicate unavailability during a sensing window to its serving AP is shown. Method 3000 may include the U-STA setting 3005 the Power Management field=1 in the Frame Control field of the MAC header of a frame it transmits to its serving AP. Next the U-STA performs 3010 sensing operations with the Sensing AP during a negotiated sensing availability window with the Sensing AP. When the sensing availability window is complete, the U-STA sets 3015 the Power Management field=0 in the Frame Control field of the MAC header of a frame it transmits to its serving AP. At this point 3020, the STA is in awake state and available for data transmissions with its serving AP.

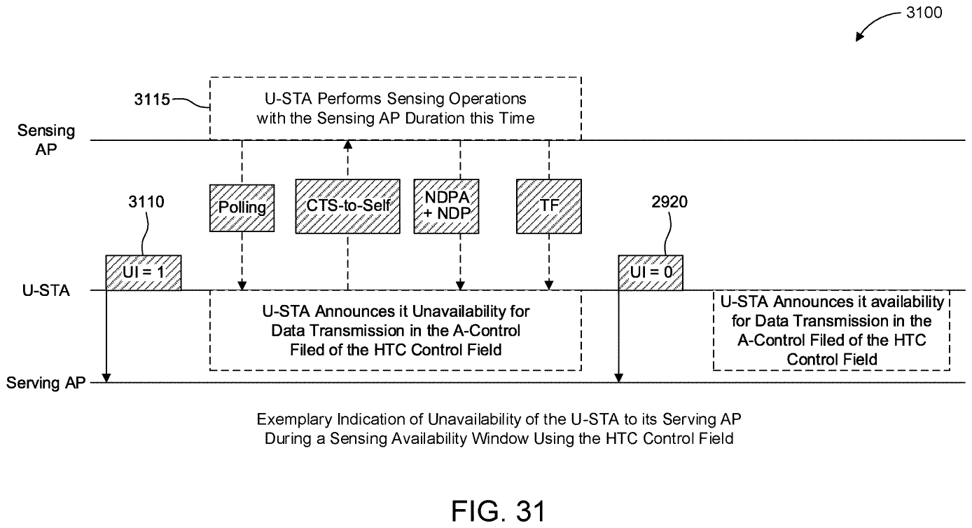

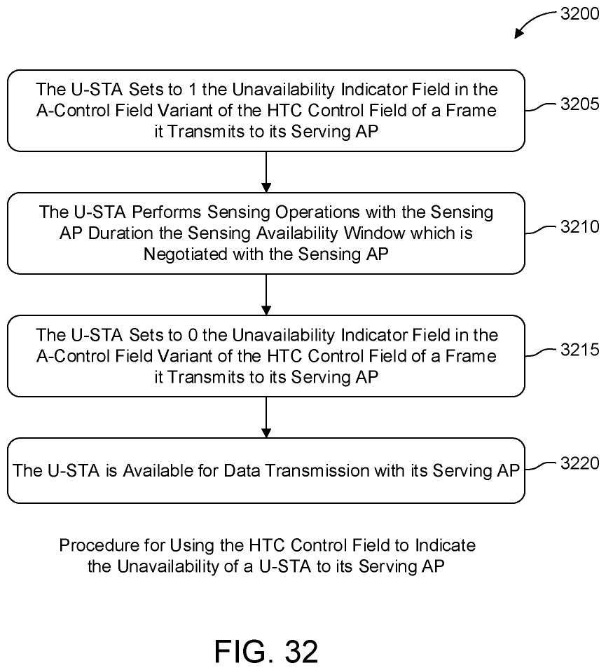

Referring to FIGS. 31 and 32, in another example, a reserved bit in the A-Control field in the HE Variant of HTC Control field may be reused to indicate the unavailability of the U-STA to its serving AP during the time it performs sensing operations in the sensing availability window with the Sensing AP.

As shown in FIG. 31 message sequence diagram 3100, in one example, a reserved bit in the CAS Control (Control And Status) variant of the A-Control field may be named/used as Unavailability Indication (UI) 3110 and set=1 to indicate the STA's unavailability during the sensing availability window 3115. Subsequently, a second UI 3120 may be set=0 to indicate that the STA is available for data transmissions with its serving AP. FIG. 32 shows a corresponding method 3200 for a sensing U-STA to indicate unavailability to its serving AP during a sensing window with a Sensing AP. Method 3200 may include the U-STA setting 3205 the UI=1 in the Frame Control field of the MAC header of a frame it transmits to its serving AP. Next the U-STA performs 3210 sensing operations with the Sensing AP during a negotiated sensing availability window with the Sensing AP. When the sensing availability window is complete, the U-STA sets 3215 the UI=0 in the Frame Control field of the MAC header of a frame it transmits to its serving AP. At this point 3220, the STA is available for data transmissions with its serving AP.

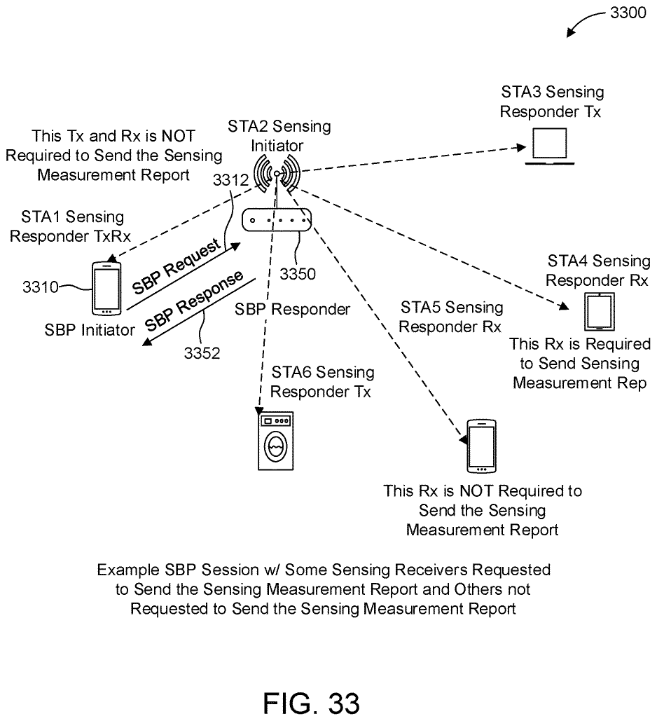

Procedures to Signal to Responder Receivers to Report the Sensing Measurements in a Sensing-by-Proxy (SBP) operation are disclosed. Referring to FIG. 33, an example SBP operational architecture 3300 is shown. As shown, STA 1 is the SBP initiator 3310 (which may also be a sensing responder) may signal an SBP request 3312 to the SBP responder 3350 (i.e., to STA 2, which is also the sensing initiator). In the example shown, STA 2 is a sensing-enabled AP. The SBP request 3312 may signal whether the sensing receivers (Rx) are requested to send the sensing measurement report back to the sensing initiator 3350 or not. For instance, in FIG. 33, the SBP initiator 3310 may indicate to the SBP responder 3350 that STA 3 and STA 6 are sensing transmitters (Tx), STA 4 and STA 5 are sensing receivers (Rx), and STA 1 is both sensing transmitter and sensing receiver (TxRx). The SBP initiator 3310 may also signal that STA 4 is required to send the sensing measurement report, but STA 5 is not required to send the sensing measurement report.

In one embodiment, an SBP initiator 3310 may request that all responders acting as receivers and participating in a sensing session that is initiated by the SBP responder 3350 shall send the sensing measurement report by default via setting a Sensing Measurement Parameters element (e.g., element 1400 of FIG. 14) in the SBP Request frame (e.g., SBP Request frame 1100 of FIG. 11).

In one embodiment, a SBP initiator 3310 may request that all responders acting as receivers and participating in a sensing session that is to be initiated by the SBP responder 3350, shall not send the sensing measurement report by default by setting=0 the Sensing Measurement Report Requested field in the Sensing Measurement Parameters field (e.g., 1500 of FIG. 15) in the Sensing Measurement Parameters element (e.g., 1400 of FIG. 14) in the SBP Request frame (e.g., 1100 of FIG. 11).

In one embodiment, the SBP Parameters Control field may include a new field named Report Requested Bitmap Present as illustrated in Table 4 below. If the Report Requested Bitmap Present is set=1, a newly added field named Report Requested Bitmap is present in the SBP Parameters element as illustrated in Table 5 below.

TABLE 4
Exemplary Enhanced SBP Parameters Control field format

| | | SBP Procedure | | Number of | Mandatory | Preferred |
|---|---|---|---|---|---|---|
| | | Expiry | Sensing | Sensing | Number of | Responder |
| | SBP Request | Exponent | Responder | Responders | Responders | List |
| Bits: | 1 | 4 | 1 | 4 | 1 | 1 |

| | Number of | Mandatory | SR2SR | Preferred | | |
|---|---|---|---|---|---|---|
| | Preferred | Preferred | Sounding | Responder Role | Report Requested | |
| | Responders | Responder | Request | Bitmap Present | Bitmap Present | Reserved |
| Bits: | 4 | 1 | 1 | 1 | 1 | 4 |

TABLE 5
Exemplary Enhanced SBP Parameters element format

| | | | | | | | Sensing | |
|---|---|---|---|---|---|---|---|---|
| | | | | SBP | Sensing | Sensing | Responder | Report |
| | Element | | Element ID | Parameters | Responder | Responder | Role | Requested |
| | ID | Length | Extension | Control | Addresses | IDs | Bitmap | Bitmap |
| Octets: | 1 | 1 | 1 | 3 | 0 or n × 6 | 0 or | 0 or | 0 or |
| | | | | | | variable | variable | variable |

In one embodiment, the Report Requested Bitmap field indicates whether each one of the preferred sensing responders that is assigned the role of receiver (Rx) or the role of both transmitter and receiver (TxRx) is required to transmit the sensing measurement report. The Report Requested Bitmap uses m bits which are listed in the same order of the m corresponding responders listed in the Sensing Responder Addresses and are assigned the role of receiver or the role of both transmitter and receiver as indicated by the Sensing Responder Role Bitmap field (e.g., last field of SBP Parameters element format 1200 of FIG. 12).

In one embodiment, the encoding of each bit of the Report Requested Bitmap field is given in Table 6.

TABLE 6
Exemplary Encoding of each bit of
the Report Requested Bitmap field

| Encoding | Meaning |
|---|---|
| 0 | The sensing responder is not required to send the sensing |
| | measurement report |
| 1 | The sensing responder is required to send the sensing |
| | measurement report |

In one embodiment, if the Report Requested Bitmap Present field within the SBP Parameters Control field in the SBP Request frame sent by the SBP initiator is set=1, the Report Requested Bitmap field may be present in the SBP Request frame. The Report Requested Bitmap field may include m bits, each of which corresponds to one of the preferred responders that are assigned the role of receiver or the role of both transmitter and receiver. Each bit of The Report Requested Bitmap field may be set to the value=1 to indicate that the corresponding responder is not required to send the sensing measurement report and may be set=0 to indicate that the corresponding responder is required to send the sensing measurement report.

In one embodiment, if the Report Requested Bitmap Present field within the SBP Parameters Control field in the SBP Request frame sent by the SBP initiator is set=1 and if the Status Code field in the SBP Response frame sent by the SBP Responder is set to SUCCESS, the SBP Responder 3350 may set the Sensing Measurement Report Requested field in the Sensing Measurement Parameters field in the Sensing Measurement Request frame according to the value of the corresponding bit in the Report Requested Bitmap such that each bit is mapped to one of the preferred sensing responders as listed in the Sensing Responder Addresses field in the SBP Parameters element (e.g., 1200 of FIG. 12) which is assigned the role of receiver or the role of both transmitter and receiver, as indicated by the Sensing Responder Role Bitmap field in the SBP Parameters element.

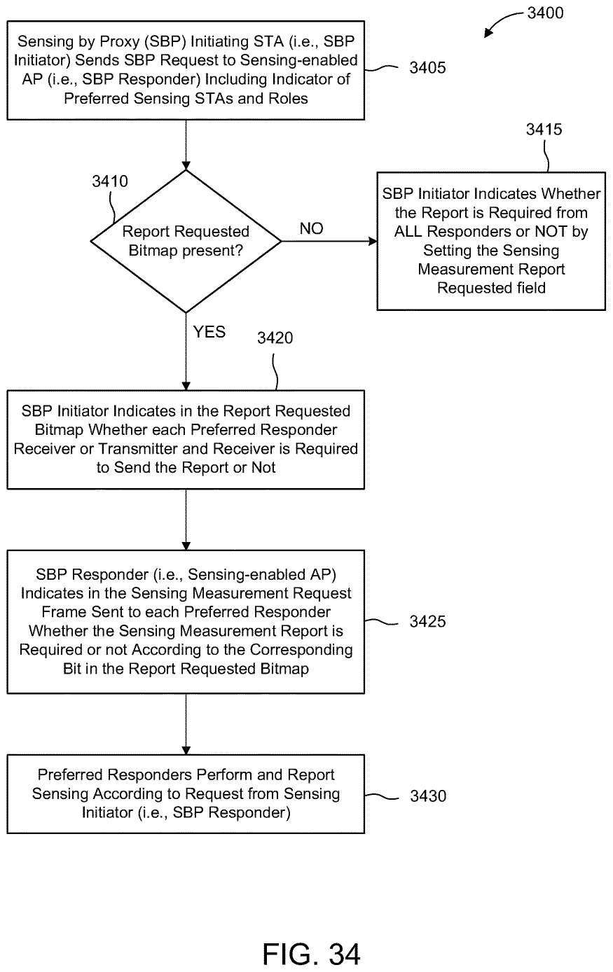

Referring to FIG. 34, an example method 3400 for a STA initiating a SBP sensing operation is shown. Method 3400 may include the STA/SBP Initiator sending 3405 a sensing by proxy (SBP) request to a sensing-enabled STA (e.g., a sensing-enabled access point (AP), i.e., the SBP Responder. In this context, a sensing-enabled STA is a STA/AP capable of initiating a sensing request to other network devices on behalf of the SBP Initiator. The SBP request may indicate preferred sensing STAs, including potentially itself (i.e., the SBP Initiator) as previously described. If 3410, the SBP request does not include a report requested bitmap, the SBP Initiator STA indicates 3415 whether the report is required from all responders or not by setting the sensing measurement report requested field. If 3410, the SBP request does include a report requested bitmap, the SBP Initiator indicates 3420 in the report requested bitmap whether each preferred responder receiver or transmitter and receiver is required to send the sensing measurement report or not. The SBP Responder (i.e., sensing-enabled AP, which is now a Sensing Measurement Initiator by proxy) sends 3425 a sensing measurement request frame to each indicated preferred responder. The sensing measurement request frame indicates whether the sensing measurement report is required or not from the preferred responders according to the corresponding bit in the report requested bitmap. Next, the preferred responders, which may include the SBP Initiating STA, perform and report sensing according to the request from the Sensing Measurement Initiator (i.e., SBP Responder). The SBP Initiator receives a SBP response from the SBP Responder (i.e., by proxy, the Sensing Measurement Initiator). The SBP response will include sensing results collected by the Sensing Measurement Initiator from indicated preferred sensing STA that sent a sensing measurement response to the Sensing Measurement Initiator.

In one example, the SBP Initiator STA receives a SBP sensing measurement report from the SBP Responder STA including a compilation of sensing reports/data received from preferred sensing STAs indicated in the SBP Request and used in the sensing measurement requests by the Sensing Measurement Initiator. Unless contrary to physical impossibility, the embodiments disclosed herein may use any element/field/subfield described herein, any combination of elements/fields/subfields and/or omit steps and/or elements/fields/subfields. Additionally, while the example embodiments described previously infer the SBP initiating STA is aware of, and requests sensing results from, preferred sensing STAs which are indicated to the SBP responder, there may be additional steps of identifying preferred receiving STAs in communications between the SBP initiator and SBP responder prior to the SBP request, which are not explicitly shown or described. In one example, the SBP Initiating STA may obtain preferred responders information from the application layer by configuration from a service provider or customer/user.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this specific implementation and are applicable to other wireless systems as well.

Although SIFS may be used to indicate various inter frame spacing in the examples of the designs and procedures, all other inter frame spacing such as RIFS, AIFS, DIFS or other agreed time interval could be applied in the same solutions. A Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for a station (STA), the method comprising:
sending a sensing by proxy (SBP) request to a sensing-enabled access point (AP), the SBP request including an indicator designating one or more preferred receiver STAs requested to perform sensing measurements; and
receiving a SBP response from the sensing-enabled AP in response to the SBP request, wherein the SBP response includes a SBP sensing measurement report including sensing measurement results of the indicated one or more preferred receiver STAs.

2. The method of claim 1, wherein the one or more preferred receiver STAs includes at least one STA that is unassociated (U-STA) with the sensing-enabled AP.

3. The method of claim 1, wherein the SBP request indicator comprises a report requested bitmap indicating at least one of preferred receiver STAs that should provide sensing measurement reports or receiver STAs that should not provide sensing measurement reports.

4. The method of claim 1, wherein the STA is designated in the SBP request indicator as a preferred receiver STA and wherein prior to receiving the SBP response, the method further comprises:
receiving, from the sensing-enabled AP, a sensing measurement request;
performing one or more sensing measurements in accordance with the received sensing measurement request; and
sending, to the sensing-enabled AP, a sensing measurement response including the one or more sensor measurements.

5. The method of claim 1, wherein the SBP request indicator further includes a role designation of whether the one or more preferred receiver STAs is a sensing responder receiving (Rx) STA or a sensing responder transmitting (Tx) and receiving (Rx) STA.

6. A station (STA) comprising:
a transceiver and a processor communicatively coupled to the transceiver, the transceiver and processor configured to:
send a sensing by proxy (SBP) request to a sensing-enabled access point (AP), the SBP request including an indicator designating one or more preferred receiver STAs requested to perform sensing measurements; and
receive a sensing by proxy (SBP) response from the sensing-enabled AP in response to the SBP request, wherein the SBP response includes a SBP sensing measurement report including sensing measurement results of the indicated one or more preferred receiver STAs.

7. The STA of claim 6, wherein the one or more preferred receiver STAs includes at least one STA that is unassociated (U-STA) with the sensing-enabled AP.

8. The STA of claim 6, wherein the SBP request indicator comprises a report requested bitmap indicating at least one of preferred receiver STAs that should provide sensing measurement reports or receiver STAs that should not provide sensing measurement reports.

9. The STA of claim 6, wherein the STA is designated in the SBP request indicator as a preferred receiver STA and wherein prior to receiving the SBP response, the transceiver and processor are further configured to:
receive, from the sensing-enabled AP, a sensing measurement request;
perform one or more sensor measurements in accordance with the received sensing measurement request; and
send, to the sensing-enabled AP, a sensing measurement response including the one or more sensor measurements.

10. The STA of claim 6, wherein the indicator designating one or more preferred receiver STAs requested to perform sensing measurements further includes a role designation of whether the one or more preferred receiver STAs is a sensing responder receiving (Rx) STA or a sensing responder transmitting (Tx) and receiving (Rx) STA.

11. A method for an access point (AP), the method comprising:
receiving, from a station (STA), a sensing by proxy (SBP) request including an indicator designating one or more preferred receiver STAs requested to perform sensing measurements;
sending, to the designated one or more preferred receiver STAs, a sensing measurement request to perform sensing;
receiving, from the designated one or more preferred receiver STAs, a sensing measurement response including one or more sensor measurements; and
sending a sensing by proxy (SBP) response to the STA, wherein the SBP response includes a SBP sensing measurement report including the one or more sensor measurements of the sensing measurement response received from the one or more preferred receiver STAs.

12. The method of claim 11, wherein the one or more preferred receiver STAs includes at least one STA that is unassociated (U-STA) with the AP.

13. The method of claim 11, wherein the SBP request indicator comprises a report requested bitmap indicating at least one of preferred receiver STAs that should provide sensing measurement reports or receiver STAs that should not provide sensing measurement reports.

14. The method of claim 11, wherein the SBP request indicator further includes a role designation of whether the one or more preferred receiver STAs is a sensing responder receiving (Rx) STA or a sensing responder transmitting (Tx) and receiving (Rx) STA.
